(19) United States
(12) Patent Application Publication
(10) Pub. No.: US 2026/0018832 A1
(43) Pub. Date: Jan. 15, 2026

(54) CONNECTOR MODULE AND ELECTRONIC DEVICE

(71) Applicant: KYOCERA CORPORATION, Kyoto (JP)

(72) Inventors: Shintaro HORINO, Yokohama-shi, Kanagawa (JP); Masayoshi KAKINO, Yokohama-shi, Kanagawa (JP)

(21) Appl. No.: 18/992,550

(22) PCT Filed: Jul. 14, 2023
(86) PCT No.: PCT/JP2023/026149

§ 371 Date: Jan. 8, 2025

(30) Foreign Application Priority Data
Jul. 22, 2022 (JP) 2022-117506

(51) Int. Cl. H01R 13/6473; H01R 12/70; H01R 12/71; H01R 13/405

(52) U.S. Cl. CPC H01R 13/6473; H01R 12/7082; H01R 12/716; H01R 13/405

(57) ABSTRACT

According to the present disclosure, a connector module 1 includes first and second connectors 50 and 10 that are configured to engage each other. The first connector 50 includes a first insulator 60 and first contacts 70 each of which includes a first free end 75 positioned opposite to a first mount portion 71. The second connector 10 includes a second insulator 20 and second contacts 30 each of which includes a second free end 36 positioned opposite to a second mount portion 31. In a state of engagement, the first and second contacts 70 and 30 are in contact with each other on one side of the first sidewall 62b and separated from each other on the other side, the one side being closer to a center of the first connector 50, and the first and second free ends 75 and 36 are positioned on the one side.

### CROSS-REFERENCE TO RELATED APPLICATIONS

This application claims the benefit of Japanese Patent Application No. 2022-117506 filed Jul. 22, 2022, which is hereby incorporated by reference herein in its entirety.

### TECHNICAL FIELD

The present disclosure relates to a connector module and an electronic device.

### BACKGROUND OF INVENTION

Electronic devices, such as mobile phones, have been subjected to weight and size reduction in recent years. Accordingly, connectors mounted in the electronic devices are also expected to be reduced in size and height. An art of the connectors that are mounted on different circuit boards to electrically connects each other are known widely. For example, Patent Literature 1 discloses connectors that provide favorable transmission characteristics of radio-frequency signals even if the connectors are reduced in size and height.

### CITATION LIST

### Patent Literature

Patent Literature 1: Japanese Patent No. 6686145

### SUMMARY

According to an embodiment of the present disclosure, a connector module includes a first connector and a second connector, and the first connector and the second connector are configured to engage each other. The first connector includes a first insulator that includes a first sidewall of a first peripheral wall and is configured to engage the second connector. The first connector also includes a plurality of first contacts, each first contact being attached to the first sidewall and including a first mount portion and a first free end positioned opposite to the first mount portion. The second connector includes a second insulator that includes a second sidewall of a second peripheral wall and is configured to engage the first connector. The first connector also includes a plurality of second contacts, each second contact being attached to the second sidewall and including a second mount portion and a second free end positioned opposite to the second mount portion. In a state of engagement state between the first connector and the second connector, the first contact and the second contact are in contact with each other on one side of the first sidewall, the one side being closer to a center of the first connector, and are separated from each other on an other side of the first sidewall. In the state of engagement, the first free end and the second free end are positioned on the one side.

An electronic device according to an embodiment of the present disclosure includes the above connector module.

### BRIEF DESCRIPTION OF THE DRAWINGS

FIG. 1 is a perspective view, as viewed from above, illustrating the exterior of a connector module according to an embodiment, in which a first connector and a second connector are connected to each other.

FIG. 2 is a perspective view, as viewed from above, illustrating the exterior of the connector module according to an embodiment, in which the first connector and the second connector are separated from each other.

FIG. 3 is a perspective view, as viewed from above, illustrating the exterior of the second connector of FIG. 1.

FIG. 4 is an exploded perspective view, as viewed from above, illustrating the exterior of the second connector of FIG. 3.

FIG. 5 is a cross-sectional view taken along line V-V in FIG. 3.

FIG. 6 is a perspective view, as viewed from above, illustrating the exterior of the first connector of FIG. 1.

FIG. 7 is an exploded perspective view, as viewed from above, illustrating the exterior of the first connector of FIG. 6.

FIG. 8 is a cross-sectional view taken along line VIII-VIII in FIG. 1.

FIG. 9 is an enlarged cross-sectional view illustrating the region IX surrounded by the dash-dot line in FIG. 8.

FIG. 10 is a perspective view illustrating the exteriors of a first contact and a second contact that are connected to each other.

FIG. 11 is a cross-sectional view taken along line XI-XI in FIG. 1.

### DESCRIPTION OF EMBODIMENTS

Adjustment of the impedance of a connector to increase is demanded in order to achieve impedance matching. In general, a small-sized connector tends to exhibit a lower impedance. In such a small-size connector, an increase in the impedance without sacrificing the product sturdiness and reliability has not been easy.

According to the connector module and the electronic device according to an embodiment of the present disclosure, the impedance of the small-size connector can be increased.

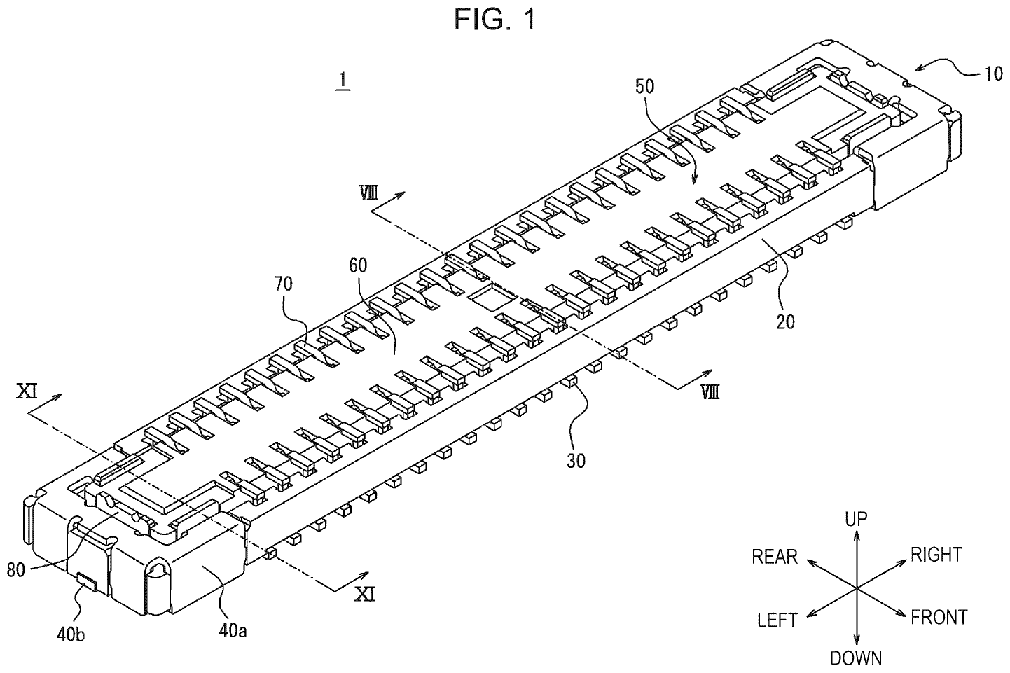

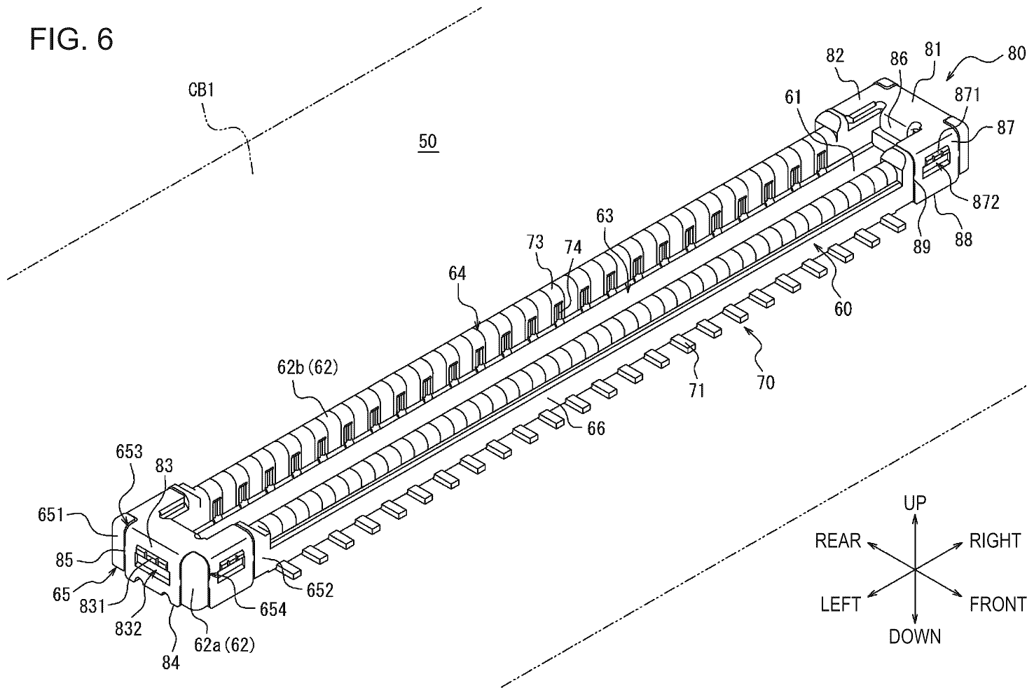

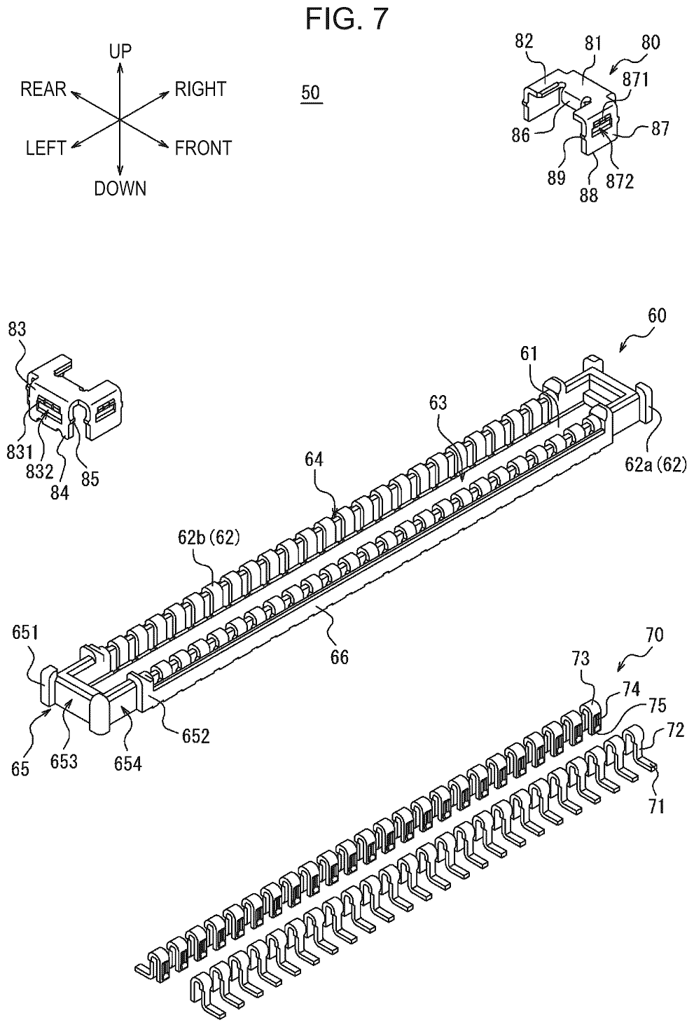

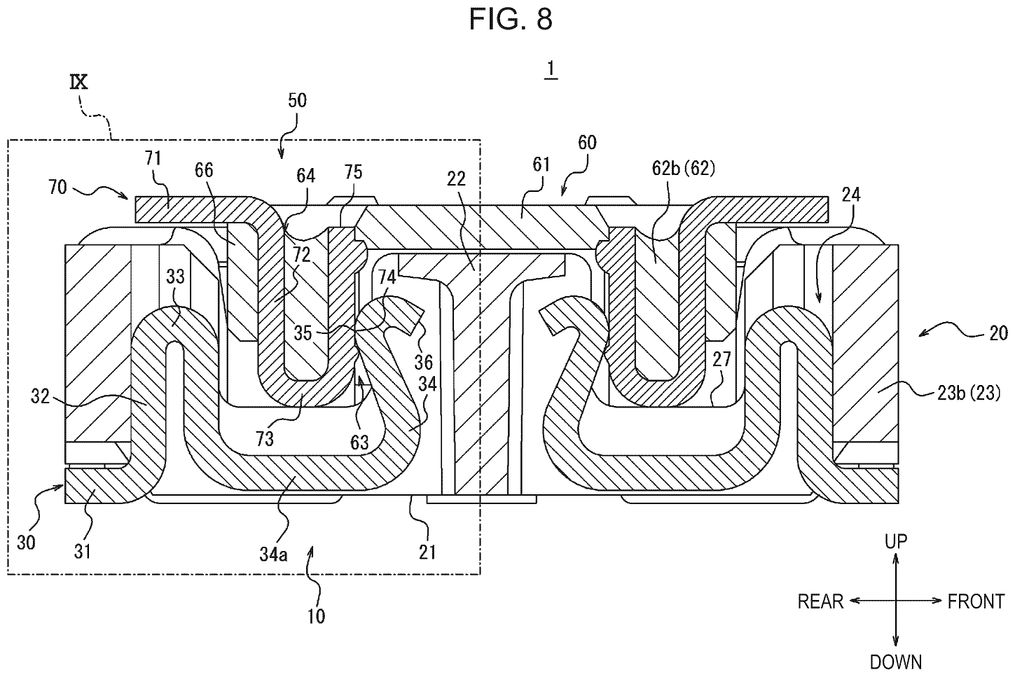

The following describes an embodiment of the present disclosure in detail with reference to the drawings. In the following description, a front-rear direction, a right-left direction, and an up-down direction are defined with reference to the directions of arrows in the drawings. The directions of arrows in FIGS. 1 to 5 and in FIGS. 8 to 11 are aligned with each other. The directions of arrows in FIGS. 6 and 7 are aligned with each other. In some drawings, illustration of circuit boards CB1 and CB2 (to be described later) is omitted to facilitate easy understanding.

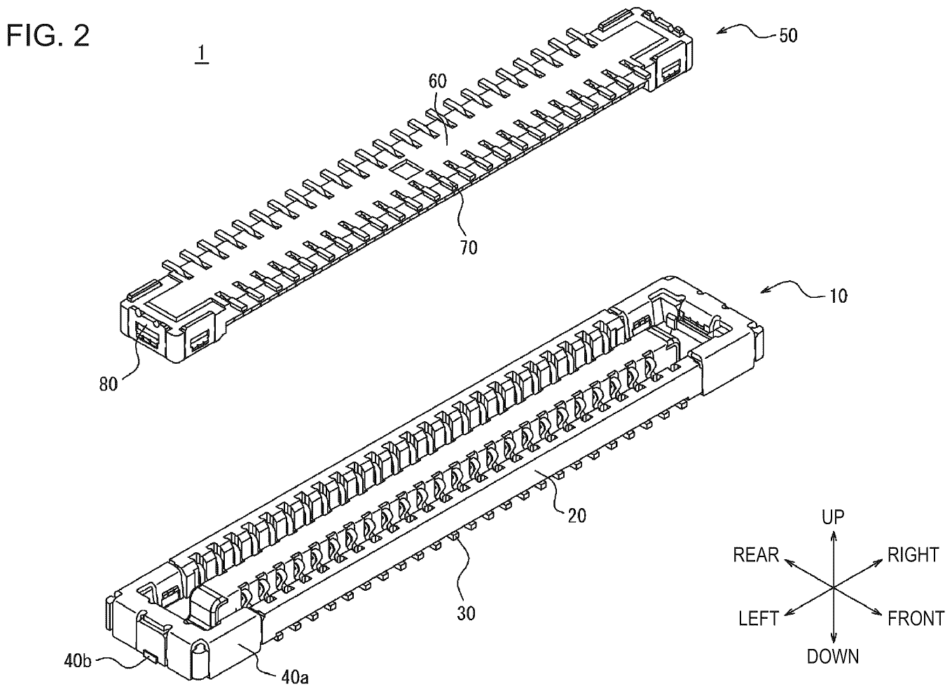

FIG. 1 is a perspective view, as viewed from above, illustrating the exterior of a connector module 1 according to an embodiment, in which a first connector 50 and a second connector 10 are connected to each other. FIG. 2 is a perspective view, as viewed from above, illustrating the exterior of the connector module 1 according to an embodiment, in which the first connector 50 and the second connector 10 are separated from each other.

For example, as illustrated in FIG. 2, the connector module 1 includes the first connector 50 and the second connector 10 that are configured to be connected to each other. The first connector 50 serves as a connection object, and the second connector 10 is connected to the connection object. The second connector 10 includes a second insulator 20 and second contacts 30 attached to the second insulator 20. The second connector 10 also includes second metal fittings 40a and third metal fittings 40b, and these metal fittings are attached to the second insulator 20.

The first connector 50 engages the second connector 10. The first connector 50 includes a first insulator 60. The first insulator 60 engages the second insulator 20 in a state of engagement in which the first connector 50 and the second connector 10 engages each other. The first connector 50 also includes first contacts 70 attached to the first insulator 60. The first contacts 70 are in contact with respective second contacts 30 in the state of engagement between the first insulator 60 and the second insulator 20. The first connector 50 also includes first metal fittings 80 attached to the first insulator 60. Each first metal fitting 80 is in contact with a second metal fitting 40a in the state of engagement. This causes the second metal fitting 40a to deform elastically.

In the following description, the second connector 10 of an embodiment is assumed to be a receptacle connector by way of example. The first connector 50 is assumed to be a plug connector by way of example. More specifically, in the state of engagement between the second insulator 20 and the first insulator 60, the second connector 10 in which the second contacts 30 are deformed elastically is assumed to be the receptacle connector. The first connector 50 in which the first contacts 70 are not deformed elastically in the state of engagement is assumed to be the plug connector. The types of the second connector 10 and the first connector 50 are not limited to those described above. For example, the second connector 10 may serve as the plug connector, while the first connector 50 may serve as the receptacle connector.

In the following description, the first connector 50 and the second connector 10 are assumedly mounted on circuit boards CB1 and CB2, respectively. The circuit board CB1 and the circuit board CB2 are electrically coupled to each other in the connection state in which the first connector 50 and the second connector 10 are connected to each other. The circuit boards CB1 and CB2 may be rigid substrates or may be any arbitrary circuit boards other than the rigid substrates. For example, at least one of the circuit boards CB1 and CB2 may be an FPC (flexible printed circuit board).

In the following description, the first connector 50 and the second connector 10 are assumedly connected to each other in a direction normal to the circuit boards CB1 and CB2. The first connector 50 and the second connector 10 are connected to each other, for example, in the up-down direction. The direction of connection is not limited to the up-down direction. The first connector 50 and the second connector 10 may be connected to each other in a direction parallel to the circuit boards CB1 and CB2. The first connector 50 and the second connector 10 may be connected to each other in such a manner that one of the first connector 50 and the second connector 10 is mounted vertically onto a circuit board and the other is mounted horizontally onto the other circuit board.

In the present disclosure, the term “engaging direction” corresponds, for example, to the up-down direction. For example, the term “longitudinal direction” corresponds to the right-left direction. For example, the term “arrangement direction” corresponds to the right-left direction. For example, the term “transverse direction” corresponds to the front-rear direction. For example, the term “engagement side” corresponds to a lower side. For example, the term “pull-out side” corresponds to an upper side. For example, the term “side near the circuit board CB2” corresponds to a lower side. For example, the term “side opposite to the circuit board CB2” corresponds to an upper side. The term “inside” corresponds to a side facing the center of the first connector 50 or the second connector 10. For example, the inside in the front-rear direction corresponds to the side facing the center of the first connector 50 or the second connector 10 in the front-rear direction. The “inside” is not limited to the side facing directly to the center in the front-rear direction but may be a side facing somewhat obliquely toward the center. This also applies to the above-described sides and directions. The term “outside” is a side opposite to the inside.

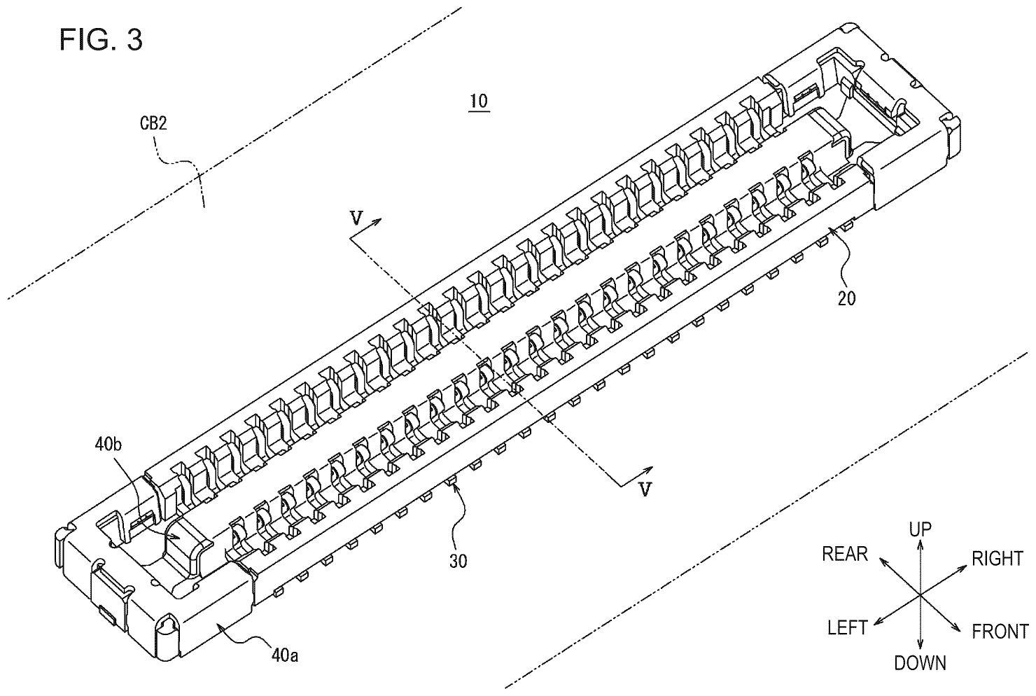

FIG. 3 is a perspective view, as viewed from above, illustrating the exterior of the second connector 10 of FIG. 1. The second connector 10 can be obtained, for example, by forming the second insulator 20 integrally with third metal fittings 40b using insert molding, while the second contacts 30 and the second metal fittings 40a are press-fitted into the second insulator 20.

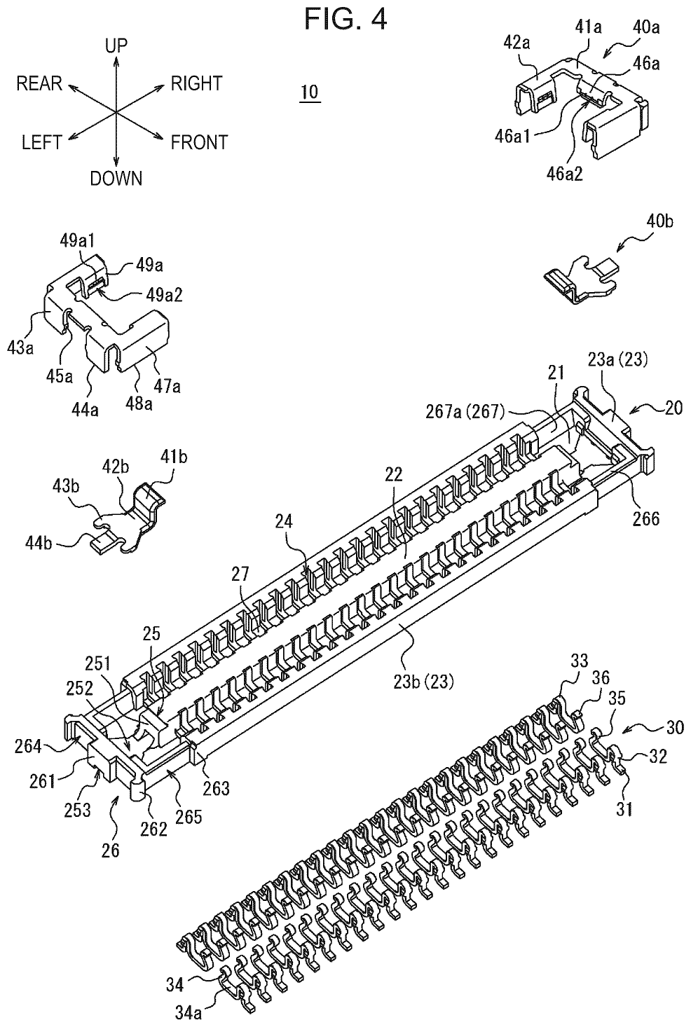

FIG. 4 is an exploded perspective view, as viewed from above, illustrating the exterior of the second connector 10 of FIG. 3. Although the second insulator 20 and the third metal fittings 40b are formed integrally by insert molding in reality, the second insulator 20 and the third metal fittings 40b are illustrated separately in FIG. 4 for the sake of easy understanding. Note that the third-metal-fitting holding portions 25 (to be described later) of the second insulator 20 are so named merely for the sake of convenience but are not the elements that the second insulator 20 inherently possesses since the second insulator 20 and the third metal fittings 40b are, in reality, formed integrally using insert molding.

The second insulator 20 of the second connector 10 is a member made of a synthetic resin having insulating and heat-resisting properties. The second insulator 20 is shaped like a plate elongated in the right-left direction. The second insulator 20 includes a bottom plate 21 that constitutes the bottom part thereof. The second insulator 20 includes an engagement projection 22 that projects upward from a central region of the bottom plate 21, the central region being located at the center in the front-rear and right-left directions. The second insulator 20 includes peripheral walls 23 that surround the engagement projection 22. The peripheral walls 23 are disposed along the periphery of the second connector 10. The peripheral walls 23 surround the engagement projection 22 in four directions in the front-rear and right-left directions. The peripheral walls 23 include transverse walls 23a and longitudinal walls 23b. The transverse walls 23a extend in the front-rear direction. The longitudinal walls 23b extend in the right-left direction.

The second insulator 20 includes second-contact mounting grooves 24. Each second-contact mounting groove 24 is disposed continuously in the front-rear direction along the inner surface of a longitudinal wall 23b, the bottom plate 21, and an inner surface of the engagement projection 22. A second contact 30 is mounted in each second-contact mounting groove 24. Multiple second-contact mounting grooves 24 are provided, and the number of the second-contact mounting grooves 24 corresponds to the number of the second contacts 30. The second-contact mounting grooves 24 are arranged in the arrangement direction of the second contacts 30.

The second insulator 20 includes third-metal-fitting holding portions 25. Each third-metal-fitting holding portion 25 extends from one end of the engagement projection 22 in the right-left direction to a corresponding transverse wall 23a along the bottom plate 21. The third-metal-fitting holding portion 25 includes a first portion 251 recessed in each end portion of the engagement projection 22, the end portion being positioned in the right-left direction. The third-metal-fitting holding portion 25 includes a second portion 252 disposed so as to pierce through the bottom plate 21. The third-metal-fitting holding portion 25 includes a third portion 253 recessed at the bottom surface of the transverse wall 23a. A third metal fitting 40b is attached to the third-metal-fitting holding portion 25. The third-metal-fitting holding portion 25 extends in the right-left direction so as to connect the engagement projection 22 and the transverse wall 23a.

The second insulator 20 includes second-metal-fitting mounting portions 26. Each second-metal-fitting mounting portion 26 is disposed continuously along the transverse wall 23a and also along corresponding end portions of the longitudinal walls 23b, the end portions being positioned in the right-left direction. A second metal fitting 40a is mounted in the second-metal-fitting mounting portion 26.

Each second-metal-fitting mounting portion 26 includes a first wall portion 261. The first wall portion 261 is disposed in a central region of the corresponding transverse wall 23a in the front-rear direction, and the first wall portion 261 protrudes outward in the right-left direction. A third portion 253 of the third-metal-fitting holding portion 25 is recessed at the bottom surface of the first wall portion 261. The second-metal-fitting mounting portion 26 includes second wall portions 262. The second wall portions 262 are disposed at the transverse wall 23a at respective corner portions of the second insulator 20. The second-metal-fitting mounting portion 26 includes third wall portions 263. Each third wall portion 263 is disposed at a longitudinal wall 23b so as to be spaced from the corresponding second wall portion 262 in the right-left direction. The first wall portion 261, the second wall portions 262, the third wall portions 263 define a rectangular outermost shape of the second insulator 20, the rectangular outermost shape extending in the front-rear and right-left directions.

The second-metal-fitting mounting portion 26 also includes first mounting grooves 264 that are disposed between the first wall portion 261 and respective second wall portions 262. The second-metal-fitting mounting portion 26 also includes second mounting grooves 265 each of which is formed between each second wall portion 262 and the corresponding third wall portion 263.

The second-metal-fitting mounting portion 26 includes fourth wall portions 266. Each fourth wall portion 266 extends straight in the right-left direction between the corresponding third wall portion 263 and the transverse wall 23a. The height of the fourth wall portion 266 in the up-down direction is smaller than that of the other portion of the longitudinal wall 23b. The second-metal-fitting mounting portion 26 includes abutting portions 267 on respective fourth wall portions 266. Each abutting portion 267 is disposed continuously inside the peripheral wall 23.

The abutting portion 267 is formed so as to come more inward from the peripheral wall 23 as the abutting portion 267 comes closer to an engagement side. Here, the engagement side is opposite to the pull-out side in the engaging direction of the first connector 50 with respect to the second connector 10. For example, the abutting portion 267 includes a slope 267a formed at the fourth wall portion 266 (i.e., the longitudinal wall 23b). The slope 267a extends toward the engagement side in the engaging direction while inclining inward in the front-rear direction from the peripheral wall 23. The abutting portion 267, which includes the slope 267a, extends in the right-left direction along the fourth wall portion 266 substantially entirely from the transverse wall 23a to the third wall portion 263.

The second insulator 20 includes projected portions 27 at the bottom plate 21. Each projected portion 27 is disposed between adjacent second-contact mounting grooves 24. The projected portion 27 has a thickness in the up-down direction, and the thickness is greater than that of the end portions of the bottom plate 21, the end portions being positioned in the right-left direction. Multiple projected portions 27 are provided, and the number of the projected portions 27 corresponds to the number of the second-contact mounting grooves 24. The projected portions 27 are arranged in the arrangement direction of the second contacts 30. The second-contact mounting grooves 24 and the projected portions 27 are disposed alternately in the right-left direction in the bottom plate 21.

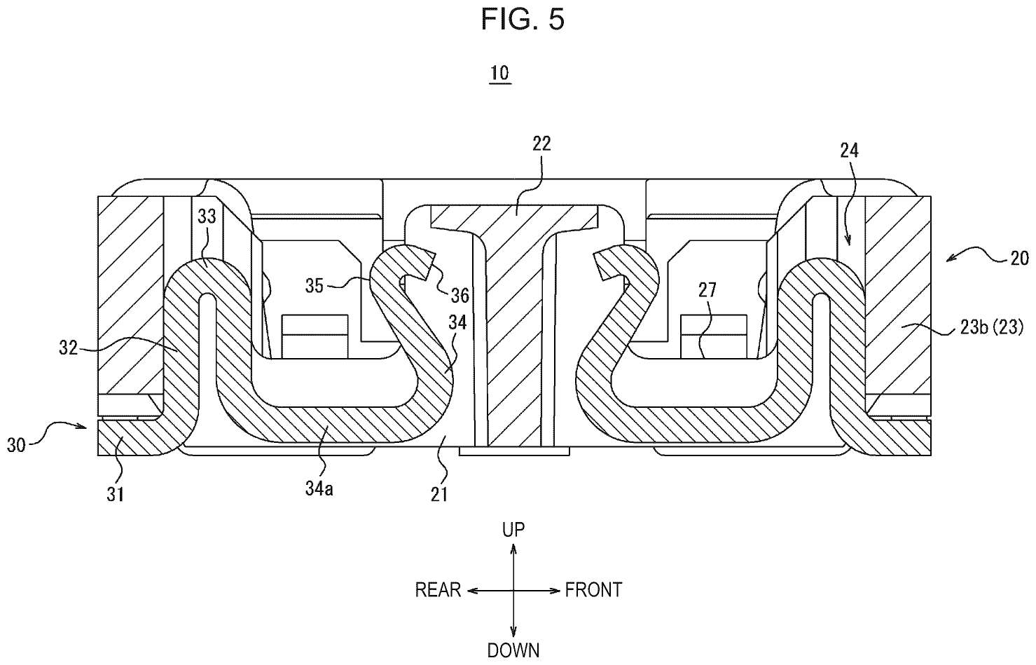

FIG. 5 is a cross-sectional view taken along line V-V in FIG. 3. The following description focuses on the structure of the second contact 30 with reference mainly to FIGS. 4 and 5.

Each second contact 30 is made, for example, of a thin plate that has spring elasticity and is made of a copper alloy, such as phosphor bronze, beryllium copper, or copper-titanium alloy, or of a Corson system copper alloy. The second contact 30 is formed of the thin plate using progressive metal forming (stamping) so as to have a shape illustrated in FIGS. 4 and 5. The surface of the second contact 30 is plated with nickel to form a foundation layer and further plated with gold or tin thereover.

The second contact 30 includes a mount portion 31 that is an L-shaped extension extending outward in the front-rear direction. The second contact 30 also includes a locking portion 32 that extends upward from the upper end of the mount portion 31. The locking portion 32 is formed so as to be wider in the right-left direction than the mount portion 31. The second contact 30 includes a curved portion 33 shaped like the letter U. The curved portion 33 protrudes upward from the locking portion 32.

The second contact 30 includes an elastic contact arm 34 that is continuous to the curved portion 33 and is shaped like the letter S. The second contact 30 includes an extension portion 34a that is positioned under the elastic contact arm 34 and extends straight in the front-rear direction from the lower end of the curved portion 33. The second contact 30 includes an elastic contact point 35. The elastic contact point 35 is disposed at the bent end portion of the elastic contact arm 34. The elastic contact point 35 faces outward in the front-rear direction. The second contact 30 also includes a free end 36 that is positioned at the end opposite to the mount portion 31. The free end 36 is positioned at an end of the elastic contact arm 34, the end being opposite to the portion continuous to the curved portion 33 in the front-rear direction.

The following description focuses on the structure of the second metal fitting 40a with reference mainly to FIG. 4.

Each second metal fitting 40a is formed of a thin plate of an arbitrary metal so as to have a shape illustrated in FIG. 4 using the progressive metal forming (stamping). The method of manufacturing the second metal fitting 40a includes a step of punching out a piece and a step of bending the punched piece in the thickness direction. The second metal fitting 40a, however, may be manufactured using a method that includes a drawing step

The second metal fitting 40a includes a first base portion 41a that extends in the front-rear direction. The second metal fitting 40a also includes second base portions 42a that extend toward one side in the right-left direction from respective ends of the first base portion 41a, the ends being positioned in the front-rear direction. The second metal fitting 40a includes protruding portions 43a that extend straight downward from respective front and rear portions of the first base portion 41a. A pair of the protruding portions 43a, which are spaced in the front-rear direction, have respective edges that oppose each other. These edges of the protruding portions 43a and an edge of the first base portion 41a in the right-left direction define a recess. The second metal fitting 40a includes first mount portions 44a positioned at the lower ends of respective protruding portions 43a. In the second metal fitting 40a, each protruding portion 43a includes a first locking portion 45a that is formed wider in the front-rear direction than the other portions.

The second metal fitting 40a includes a bent portion 46a. The bent portion 46a is bent toward the one side in the right-left direction from a central portion of an edge of the first base portion 41a, in which the central portion is positioned in the front-rear direction and the edge is positioned in the right-left direction. The second metal fitting 40a includes a first fitting portion 46a1 disposed at a surface of the bent portion 46a, the surface facing the one side in the right-left direction. The first fitting portion 46a1 includes a projection projecting from the surface of the bent portion 46a toward the one side in the right-left direction. The second metal fitting 40a also includes a second fitting portion 46a2 disposed at the surface of the bent portion 46a at a position directly below the first fitting portion 46a1. The second fitting portion 46a2 includes a recess recessed from the surface of the bent portion 46a toward the other side in the right-left direction.

The second metal fitting 40a also includes second locking portions 47a that extend downward from respective second base portions 42a. Each second locking portion 47a extends downward from a substantially entire portion of an edge of the corresponding second base portion 42a, the edge extending in the right-left direction and facing outward in the front-rear direction. Each second locking portion 47a includes a wide portion that is wider in the right-left direction than the second base portion 42a. The second metal fitting 40a includes second mount portions 48a. Each second mount portion 48a is positioned at the lower end of each second locking portion 47a and extends almost over the entire length of the lower end in the right-left direction.

The second metal fitting 40a includes extended portions 49a. Each extended portion 49a extends inward into the second metal fitting 40a from the edge of the corresponding second base portion 42a, the edge being positioned opposite to the second locking portion 47a. The extended portion 49a extends obliquely downward from an end portion of the edge of the second base portion 42a, the edge facing inward in the front-rear direction and the end portion being closer to the one side in the right-left direction. The extended portion 49a extends to a position below the center of the second locking portion 47a, the center being positioned in the up-down direction. The extended portion 49a extends downward while inclining inward in the front-rear direction. When the extended portion 49a receives a contact pressure due to the first connector 50 coming into contact, the extended portion 49a can elastically deform, from a free state, toward the second locking portion 47a in the front-rear direction. The extended portion 49a has spring elasticity.

The second metal fitting 40a includes first fitting portions 49a1. Each first fitting portion 49a1 is disposed at the surface of the corresponding extended portion 49a, the surface facing opposite to the second locking portion 47a in the front-rear direction. The first fitting portion 49a1 includes a projection projecting from the surface of the extended portion 49a in the direction opposite to the second locking portion 47a. The second metal fitting 40a also includes second fitting portions 49a2. Each second fitting portion 49a2 is disposed at the surface of the corresponding extended portion 49a at a position directly below the first fitting portion 49a1. The second fitting portion 49a2 includes a recess recessed from the surface of the extended portion 49a toward the second locking portion 47a.

The following description focuses on the structure of the third metal fitting 40b with reference mainly to FIG. 4.

Each third metal fitting 40b is formed of a thin plate of an arbitrary metal so as to have a shape illustrated in FIG. 4 using the progressive metal forming (stamping). The method of manufacturing the third metal fitting 40b includes a step of punching out a piece and a step of bending the punched piece in the thickness direction. The method, however, is not limited to this. The third metal fitting 40b may be manufactured using a method including a drawing step so that the surfaces of a first base portion 41b (to be described later) that face upward or in the front-rear or right-left direction can be connected together seamlessly.

The third metal fitting 40b as a whole has a crank-like shape. More specifically, the third metal fitting 40b includes the first base portion 41b and a second base portion 42b (to be described later), and these portions are integrally formed so as to have the crank-like shape as a whole.

The third metal fitting 40b includes the first base portion 41b. The first base portion 41b extends straight upward and is bent, at the upper end thereof, toward the one side in the right-left direction. The first base portion 41b is shaped like the letter L. The third metal fitting 40b includes the second base portion 42b that extends straight toward the other side in the right-left direction from the lower end of the first base portion 41b. In the front-rear direction, the width of the second base portion 42b is equal to the width of the first base portion 41b that adjoins the second base portion 42b.

The third metal fitting 40b includes a wide portion 43b that is shaped widely in the front-rear direction. The wide portion 43b includes portions that are bifurcated and extend from the end of the second base portion 42b toward the other side in the right-left direction. The third metal fitting 40b includes a mount portion 44b that extends straight toward the other side in the right-left direction from a central portion of the bifurcated wide portion 43b, the central portion being positioned in the front-rear direction. More specifically, the mount portion 44b extends obliquely downward from the wide portion 43b and then extends straight toward the other side in the right-left direction. The mount portion 44b is positioned lower than the second base portion 42b and the wide portion 43b.

As illustrated in FIG. 5, each second contact 30 is press-fitted into the second insulator 20 from below. In this state, the locking portion 32 of the second contact 30 is locked between inner surfaces of each second-contact mounting groove 24, the inner surfaces facing each other in the right-left direction. The second contact 30 is thereby held in the second-contact mounting groove 24. Multiple second contacts 30 are mounted in the longitudinal walls 23b.

When each second contact 30 is held in the corresponding second-contact mounting groove 24 of the second insulator 20, the elastic contact point 35 projects out of the second-contact mounting groove 24 into the space between the engagement projection 22 and the corresponding longitudinal wall 23b. The elastic contact arm 34 is elastically deformable in the front-rear direction inside the second-contact mounting groove 24. The free end 36 is positioned such that the upper end portion of the engagement projection 22 comes immediately above the free end 36. The tip end of each mount portion 31 is positioned in the front-rear direction so as to be substantially flush with the longitudinal wall 23b.

As illustrated in FIG. 4, the second metal fitting 40a and the third metal fitting 40b are separate members. The second metal fitting 40a is spaced from the third metal fitting 40b. In the separated state, the second metal fitting 40a opposes the third metal fitting 40b in the right-left direction. The second metal fitting 40a and the third metal fitting 40b have different strengths. In other words, the strength of one of the second metal fitting 40a and the third metal fitting 40b is greater than the strength of the other. For example, the strength of the third metal fitting 40b may be greater than that of the second metal fitting 40a. For example, the strength of the material of the third metal fitting 40b may be greater than that of the material of the second metal fitting 40a. For example, the term “strength” as used herein includes tensile strength.

The second metal fitting 40a and the third metal fitting 40b may be made of different materials. For example, the material of the third metal fitting 40b may be stainless steel, and the material of the second metal fitting 40a may be phosphor bronze. The materials are not limited to the above. The material of the second metal fitting 40a and the material of the third metal fitting 40b may be selected arbitrarily from a group of material candidates so as to satisfy the condition that the strength of the third metal fitting 40b is greater than the strength of the second metal fitting 40a. The term “group of material candidates” as used herein includes, for example, stainless steel, phosphor bronze, iron, Corson copper, copper titanium, beryllium copper, and aluminum.

The third metal fitting 40b can be made of the same type of material as that of the second metal fitting 40a insofar as the strength of the third metal fitting 40b is greater than the strength of the second metal fitting 40a. Even if the third metal fitting 40b and the second metal fitting 40a are made of the same type of alloy, such as phosphor bronze, the strength of the third metal fitting 40b can be made greater than that of the second metal fitting 40a if, for example, the number, type, or quality of the alloy is different. For example, even if the third metal fitting 40b and the second metal fitting 40a are made of the same type of material, such as phosphor bronze, the thickness of the third metal fitting 40b can be made greater than that of the second metal fitting 40a (to be described again later), which increases the strength of the third metal fitting 40b relative to that of the second metal fitting 40a.

For example, the strength of the second contact 30 can be substantially the same as that of the second metal fitting 40a. The strength of the third metal fitting 40b can be greater than those of the second metal fitting 40a and the second contact 30. The materials of the second metal fitting 40a, the third metal fitting 40b, and the second contact 30 may be selected arbitrarily from the group of material candidates so as to satisfy the above strength relations among the second metal fitting 40a, the third metal fitting 40b, and the second contact 30.

A pair of the third metal fittings 40b are attached to respective ends of the engagement projection 22 of the second connector 10, the ends being positioned oppositely in the longitudinal direction. Each third metal fitting 40b extends in the longitudinal direction of the second connector 10 from the engagement projection 22 to the corresponding transverse wall 23a to which a second metal fitting 40a is attached.

For example, each third metal fitting 40b is embedded integrally in the corresponding third-metal-fitting holding portion 25 of the second insulator 20 using insert molding. Here, the first base portion 41b of the third metal fitting 40b is embedded integrally in an end portion of the engagement projection 22, the end portion being positioned in the right-left direction, so as to extend from the top surface to side surfaces of the end portion. For example, the first base portion 41b is embedded integrally in the first portion 251 of the third-metal-fitting holding portion 25. The first base portion 41b entirely covers each end portion of the engagement projection 22 from outside, each end portion being positioned in the right-left direction.

The second base portion 42b is embedded integrally in the bottom plate 21. For example, the second base portion 42b is formed integrally in a part of the second portion 252 of the third-metal-fitting holding portion 25. The wide portion 43b is embedded integrally in the remaining part of the second portion 252 of the third-metal-fitting holding portion 25. The mount portion 44b is embedded integrally in the third portion 253 of the third-metal-fitting holding portion 25. In this state, the tip end of the mount portion 44b is exposed outward in the right-left direction from the first wall portion 261 of the transverse wall 23a.

When the third metal fitting 40b and the second insulator 20 are formed integrally using insert molding, the second base portion 42b and the wide portion 43b are positioned so as to extend in the longitudinal direction of the second connector 10. The second base portion 42b and the wide portion 43b extend from the engagement projection 22 to the transverse wall 23a to which the second metal fitting 40a is attached. The bottom surface of the mount portion 44b is positioned lower than the bottom surface of the bottom plate 21 of the second insulator 20. In the right-left direction, the mount portion 44b is positioned directly below the transverse wall 23a.

The second metal fittings 40a are press-fitted into the second insulator 20 from above. Each second metal fitting 40a is attached to a corresponding one of the peripheral walls 23 in such a manner that the first wall portion 261 is held in the recess of the second metal fitting 40a. The recess is defined by the mutually opposing edges of respective protruding portions 43a that are spaced in the front-rear direction, and by the lower edge of the first base portion 41a, the edge being positioned in the right-left direction.

Here, each first locking portion 45a of the second metal fitting 40a is locked at the corresponding first wall portion 261 of the second-metal-fitting mounting portion 26 at a position outside the transverse wall 23a in the right-left direction. A pair of the protruding portions 43a spaced in the front-rear direction are fitted in respective first mounting grooves 264. Similarly, each second locking portion 47a is locked between the corresponding second wall portion 262 and third wall portion 263 of the second-metal-fitting mounting portion 26 at a position outside the longitudinal wall 23b in the front-rear direction. Each second locking portion 47a is thereby fitted in the second mounting groove 265. Thus, the second metal fitting 40a is held by the second-metal-fitting mounting portion 26.

The first base portion 41a and the second base portions 42a of the second metal fitting 40a are disposed along the peripheral walls 23. More specifically, the first base portion 41a is disposed along the transverse wall 23a. The second base portions 42a are disposed along respective longitudinal walls 23b. The extended portions 49a extend from respective second base portions 42a into the inside of the peripheral walls 23. The extended portions 49a are positioned at respective longitudinal walls 23b.

The projection included in the first fitting portion 49a1 of each extended portion 49a projects from the surface of the extended portion 49a in the direction opposite from the corresponding peripheral wall 23. A pair of the extended portions 49a are disposed so as to oppose each other in the front-rear direction. The extended portions 49a have respective first fitting portions 49a1, and the projections of the first fitting portions 49a1 oppose each other in the front-rear direction with the end portion of the engagement projection 22 being interposed therebetween, the end portion being positioned in the right-left direction. The pair of the first fitting portions 49a1 are disposed in the second metal fitting 40a at the same right-left and up-down position.

The second fitting portion 49a2 of each extended portion 49a includes a recess recessed from the surface of the extended portion 49a toward the corresponding peripheral wall 23. In the pair of the extended portions 49a disposed in the front-rear direction, the extended portions 49a have respective second fitting portions 49a2, and the recesses of the second fitting portions 49a2 oppose each other in the front-rear direction with the end portion of the engagement projection 22 being interposed therebetween, the end portion being positioned in the right-left direction. The pair of the second fitting portions 49a2 are disposed in the second metal fitting 40a at the same right-left and up-down position.

When the second metal fitting 40a is held in the second-metal-fitting mounting portion 26 of the second insulator 20, the second metal fitting 40a covers the entire transverse wall 23a and also covers part of the longitudinal walls 23b at ends in the right-left direction. In this state, the second metal fitting 40a surrounds the first base portion 41b, the second base portion 42b, and the wide portion 43b of the third metal fitting 40b from outside in the front-rear and right-left directions. More specifically, the second base portions 42a of the second metal fitting 40a are disposed at both sides of the first base portion 41b, the second base portion 42b, and the wide portion 43b of the third metal fitting 40b in the front-rear direction. The first base portion 41a, the protruding portions 43a, and the bent portion 46a of the second metal fitting 40a are positioned so as to superpose the end portion of the wide portion 43b and the mount portion 44b of the third metal fitting 40b in the right-left direction.

The first mount portions 44a of the second metal fitting 40a are disposed along the outer surface of the corresponding transverse wall 23a, the outer surface facing outward in the right-left direction. The first mount portions 44a protrude downward below the lower end of the transverse wall 23a. The first mount portions 44a are positioned respectively at both sides of the mount portion 44b of the third metal fitting 40b in the transverse direction of the second connector 10. A pair of the first mount portions 44a are positioned so as to oppose the mount portion 44b of the third metal fitting 40b from both sides in the front-rear direction. For example, the first mount portions 44a are disposed respectively at symmetrical positions in the front-rear direction with respect to the mount portion 44b of the third metal fitting 40b.

The second mount portions 48a are disposed along respective outer surfaces of the longitudinal walls 23b, the outer surfaces facing outward in the front-rear direction. The second mount portions 48a protrude downward below the lower ends of the longitudinal walls 23b. The second mount portions 48a are positioned respectively at both sides of the third metal fitting 40b in the transverse direction of the second connector 10. A pair of the second mount portions 48a are positioned so as to oppose the first base portion 41b, the second base portion 42b, and the wide portion 43b of the third metal fitting 40b from both sides in the front-rear direction. For example, the second mount portions 48a are disposed respectively at symmetrical positions in the front-rear direction with respect to the first base portion 41b, the second base portion 42b, and the wide portion 43b.

In the second connector 10 with the above-described structure, the mount portions 31 of respective second contacts 30 are soldered to patterned traces disposed on the mount surface of the circuit board CB2. The first mount portions 44a and the second mount portions 48a of each second metal fitting 40a and the mount portion 44b of the third metal fitting 40b are soldered to corresponding patterned traces disposed on the mount surface. Thus, the mount portions are fixed to the circuit board CB2, and the second connector 10 is thereby mounted on the circuit board CB2. For example, electronic components other than the second connector 10, such as a central processing unit (CPU), a controller, and a memory, are also mounted on the mount surface of the circuit board CB2.

The following describes the structure of the first connector 50 with reference mainly to FIGS. 6 and 7.

FIG. 6 is a perspective view, as viewed from above, illustrating the exterior of the first connector 50 of FIG. 1. The first connector 50 can be obtained, for example, by forming the first insulator 60 integrally with the first contacts 70 using insert molding, while the first metal fittings 80 are press-fitted into the first insulator 60 from above.

FIG. 7 is an exploded perspective view, as viewed from above, illustrating the exterior of the first connector 50 of FIG. 6. Although the first insulator 60 and the first contacts 70 are formed integrally by insert molding in reality, the first insulator 60 and the first contacts 70 are illustrated separately in FIG. 7 for the sake of easy understanding. Note that the first-contact holding portions 64 (to be described later), or the like, of the first insulator 60 are so named merely for the sake of convenience but are not the elements that the first insulator 60 originally possesses since the first insulator 60 and the first contacts 70 are, in reality, formed integrally using insert molding.

The first insulator 60 is a plate-like member elongated in the right-left direction. The first insulator 60 is made of a synthetic resin having insulating and heat-resisting properties using injection molding. The first insulator 60 includes a bottom plate 61 that constitutes the bottom part thereof. The first insulator 60 includes annularly formed peripheral walls 62 that protrude upward from peripheral portions of the bottom plate 61, the peripheral portions extending in the front-rear and right-left directions. The peripheral walls 62 include transverse walls 62a and longitudinal walls 62b. The transverse walls 62a extend in the front-rear direction. The longitudinal walls 62b extend in the right-left direction. The first insulator 60 includes an engagement recess 63 surrounded by the peripheral walls 62 in four directions, in other words, in the front-rear and right-left directions.

The first insulator 60 includes first-contact holding portions 64 each of which is formed continuously in each longitudinal wall 62b and in the bottom plate 61. The first contacts 70 are mounted in respective first-contact holding portions 64. Multiple first-contact holding portions 64 are provided, and the number of the first-contact holding portions 64 corresponds to the number of the first contacts 70. The first-contact holding portions 64 are arranged in the arrangement direction of the first contacts 70.

The first insulator 60 includes first-metal-fitting mounting portions 65. Each first-metal-fitting mounting portion 65 is disposed continuously along the corresponding transverse wall 62a and also along corresponding end portions of the longitudinal walls 62b, the end portions being positioned in the right-left direction. A first metal fitting 80 is attached to the first-metal-fitting mounting portion 65.

The first-metal-fitting mounting portion 65 includes first wall portions 651. The first wall portions 651 are disposed at the transverse wall 62a at corners of the first insulator 60. The first-metal-fitting mounting portion 65 includes second wall portions 652. Each second wall portion 652 is disposed at a longitudinal wall 62b so as to be spaced from the corresponding first wall portion 651 in the right-left direction. The first wall portions 651 and the second wall portions 652 define a rectangular outermost shape of the first insulator 60, the rectangular outermost shape extending in the front-rear and right-left directions. In the first-metal-fitting mounting portion 65, a top surface of a portion extending straight in the right-left direction between each first wall portion 651 and the corresponding second wall portion 652 has the same height as that of the top surface of each first contact 70 held by the first insulator 60.

The first-metal-fitting mounting portion 65 also includes a first mounting groove 653 disposed between a pair of the first wall portions 651. The first-metal-fitting mounting portion 65 also includes second mounting grooves 654 that are disposed between respective first wall portions 651 and corresponding second wall portions 652.

The first insulator 60 includes outer walls 66. Each outer wall 66 extends along the corresponding longitudinal wall 62b in the right-left direction so as to connect the second wall portions 652 positioned at opposite ends of the first insulator 60 in the right-left direction. Each outer wall 66 extends parallel to the longitudinal wall 62b in the arrangement direction of the first-contact holding portions 64 over the entire length of the region in which the first-contact holding portions 64 are arranged. The outer wall 66 is disposed outside of the longitudinal wall 62b in the front-rear direction and covers part of the first-contact holding portions 64 from outside in the front-rear direction.

The following description focuses on the structure of the first contact 70.

The first contact 70, which has a shape as illustrated in FIG. 7, is formed, for example, of a thin plate made of a copper alloy, such as phosphor bronze, beryllium copper, or copper-titanium alloy, or of a Corson system copper alloy, using the progressive metal forming (stamping). The surface of the first contact 70 is plated with nickel to form a foundation layer and further plated with gold or tin thereover.

The first contact 70 includes a mount portion 71 that is an L-shaped extension extending outward in the front-rear direction. The first contact 70 includes an extension portion 72 that is continuous to the mount portion 71. The extension portion 72 extends upward from the upper end of the mount portion 71. The extension portion 72 has substantially the same width in the right-left direction as that of the mount portion 71. The first contact 70 includes a fold-back portion 73 shaped like a reversed letter “J”. The fold-back portion 73 extends upward from the upper end of the extension portion 72. In the arrangement direction of the first contacts 70, the width of the extension portion 72 is smaller than the width of the fold-back portion 73. In other words, in the right-left direction, the width of the extension portion 72 is smaller than the fold-back portion 73.

The first contact 70 includes a contact point 74 disposed at the fold-back portion 73. The contact point 74 at the fold-back portion 73 constitutes part of the inner surface of the first connector 50, the inner surfaces facing the center of the first connector 50 in the front-rear direction. The first contact 70 includes a free end 75 that is positioned at the end opposite to the mount portion 71. The free end 75 is positioned directly below the contact point 74 of the fold-back portion 73. The free end 75 is connected to the extension portion 72 via the fold-back portion 73. In other words, the fold-back portion 73 connects the free end 75 to the extension portion 72.

The following description focuses on the structure of the first metal fitting 80.

The first metal fitting 80 is formed of a thin plate of an arbitrary metal so as to have a shape illustrated in FIG. 7 using the progressive metal forming (stamping). The method of manufacturing the first metal fitting 80 includes a step of punching out a piece and a step of bending the punched piece in the thickness direction.

The first metal fitting 80 includes a first base portion 81 that extends in the front-rear direction. The first metal fitting 80 also includes second base portions 82 that extend toward one side in the right-left direction from respective ends of the first base portion 81, the ends being positioned in the front-rear direction. The first metal fitting 80 includes a first protruding portion 83 that extends straight downward from a substantially entire portion of the edge of the first base portion 81, the edge facing the other side in the right-left direction.

The first metal fitting 80 includes a first fitting portion 831 disposed at a surface of the first protruding portion 83, the surface facing the other side in the right-left direction. The first fitting portion 831 includes a projection projecting toward the other side in the right-left direction from the surface of the first protruding portion 83. The first metal fitting 80 also includes a second fitting portion 832 disposed at the surface of the first protruding portion 83 at a position directly below the first fitting portion 831. The second fitting portion 832 includes a recess recessed from the surface of the first protruding portion 83 toward the one side in the right-left direction.

The first metal fitting 80 includes a first mount portion 84 positioned at the lower end of the first protruding portion 83. The first protruding portion 83 of the first metal fitting 80 includes a first locking portion 85 that is formed wider in the front-rear direction than the other portions. The first metal fitting 80 includes a bent portion 86. The bent portion 86 is bent toward the one side in the right-left direction from a central portion of an edge of the first base portion 81, in which the edge is positioned in the right-left direction and the central portion is positioned in the front-rear direction.

The first metal fitting 80 also includes second protruding portions 87 that extend downward from respective second base portions 82. Each second protruding portion 87 extends downward from a substantially entire portion of an edge of the corresponding second base portion 82, the edge extending in the right-left direction and facing outward in the front-rear direction. The first metal fitting 80 includes first fitting portions 871. Each first fitting portion 871 is disposed at a surface of the corresponding second protruding portion 87, the surface facing outward in the front-rear direction. The first fitting portion 871 includes a projection projecting outward in the front-rear direction from the surface of the second protruding portion 87. The first metal fitting 80 also includes second fitting portions 872. Each second fitting portion 872 is disposed at the surface of the corresponding second protruding portion 87 at a position directly below the first fitting portion 871. The second fitting portion 872 includes a recess recessed inward in the front-rear direction from the surface of the second protruding portion 87.

The first metal fitting 80 includes second mount portions 88 positioned at respective lower ends of the second protruding portions 87. Each second protruding portion 87 of the first metal fitting 80 includes a second locking portion 89 that is formed wider in the right-left direction than the other portions.

As illustrated in FIG. 6, the first contacts 70 are embedded integrally in the first-contact holding portions 64 of the first insulator 60 using insert molding. The first contacts 70 are mounted in the longitudinal walls 62b. Here, the contact points 74 are disposed along the inner surfaces of respective longitudinal walls 62b, the inner surfaces facing in the front-rear direction. The mount portions 71 protrude through the bottom plate 61 and further extend outward in the front-rear direction. The tip ends of the mount portions 71 are positioned outside the longitudinal walls 62b in the front-rear direction.

The first metal fittings 80 are press-fitted into the first insulator 60 from above. The first metal fittings 80 are mounted onto the peripheral walls 62. Here, the first locking portion 85 of each first metal fitting 80 is locked between the first wall portions 651 of the first-metal-fitting mounting portion 65 at a position outside the transverse wall 62a in the right-left direction. The first protruding portion 83 is thereby fitted in the first mounting groove 653. Similarly, each second locking portion 89 is locked between the corresponding first wall portion 651 and second wall portion 652 of the first-metal-fitting mounting portion 65 at a position outside the longitudinal wall 62b in the front-rear direction. Each second protruding portion 87 is thereby fitted in the corresponding second mounting groove 654. Thus, the first metal fitting 80 is held by the first-metal-fitting mounting portion 65.

The first base portion 81 and the second base portions 82 of the first metal fitting 80 are disposed along the peripheral walls 62. More specifically, the first base portion 81 is disposed along the transverse wall 62a. The second base portions 82 are disposed along respective longitudinal walls 62b.

The projection included in the first fitting portion 871 of each second protruding portion 87 projects from the surface of the second protruding portion 87 in the direction opposite to the corresponding peripheral wall 62. A pair of the second protruding portions 87, which are positioned in the front-rear direction, include respective first fitting portions 871, and a pair of the projections of the first fitting portions 871 are disposed at respective outer surfaces of opposing longitudinal walls 62b in the front-rear direction. The pair of the first fitting portions 871 are disposed at the same right-left and up-down position in the first metal fitting 80.

The recess included in the second fitting portion 872 of each second protruding portion 87 is recessed from the surface of the second protruding portion 87 toward the corresponding peripheral wall 62. A pair of the second protruding portions 87, which are positioned in the front-rear direction, include respective second fitting portions 872, and a pair of the recesses of the second fitting portions 872 are disposed at respective outer surfaces of opposing longitudinal walls 62b in the front-rear direction. The pair of the second fitting portions 872 are disposed at the same right-left and up-down position in the first metal fitting 80.

When the first metal fitting 80 is held in the first-metal-fitting mounting portion 65 of the first insulator 60, the first metal fitting 80 covers the entire transverse wall 62a and also covers part of the longitudinal walls 62b at ends in the right-left direction. The first mount portion 84 is disposed along the outer surface of the corresponding transverse wall 62a, the outer surface facing outward in the right-left direction. The first mount portion 84 protrude downward below the lower end of the transverse wall 62a. The second mount portions 88 are disposed along respective outer surfaces of the longitudinal walls 62b, the outer surfaces facing outward in the front-rear direction. The second mount portions 88 protrude downward below the lower ends of the longitudinal walls 62b.

In the engaging direction of the first connector 50 with respect to the second connector 10, the end surface of the first metal fitting 80 is positioned closer to the engagement side than the end surface of each first contact 70 to the engagement side, both of the end surfaces of the first metal fitting 80 and the first contact 70 facing in the engagement direction. When the first metal fittings 80 and the first contacts 70 are attached to the first insulator 60, the top surface of each first metal fitting 80 is positioned above the top surface of each first contact 70.

In the first connector 50 with the above-described structure, the mount portions 71 of respective first contacts 70 are soldered to patterned traces disposed on the mount surface of the circuit board CB1. The first mount portion 84 and the second mount portions 88 of each first metal fitting 80 are also soldered to corresponding patterned traces disposed on the mount surface. Thus, the first connector 50 is mounted on the circuit board CB1. For example, electronic components other than the first connector 50, including an imaging module and others, are also mounted on the mount surface of the circuit board CB1.

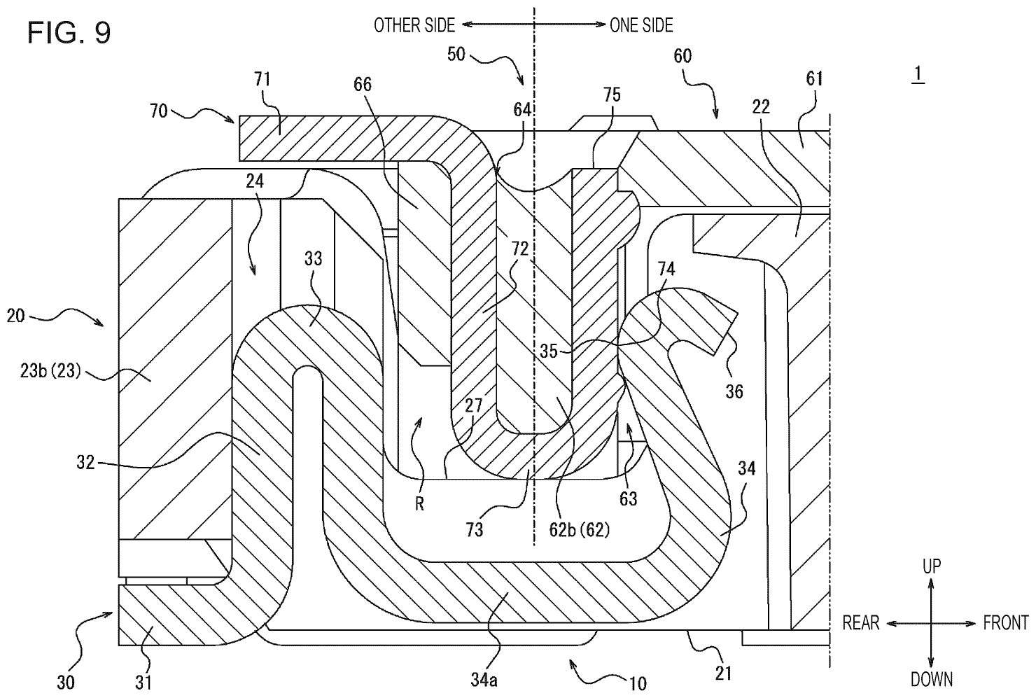

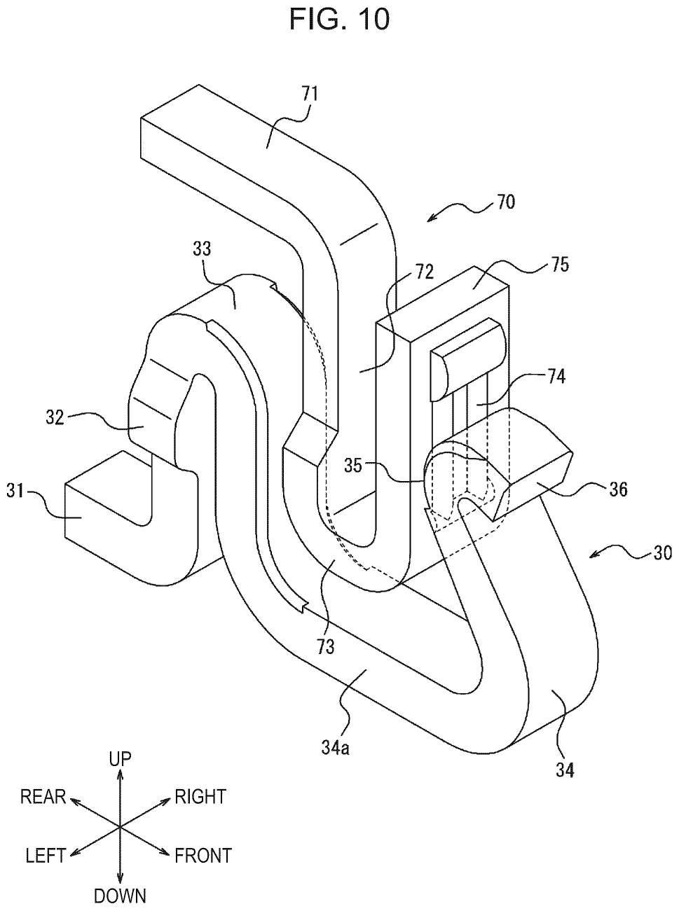

With reference to FIGS. 8 to 11, the following description focuses on the structure of the connector module 1 in the state of engagement between the first connector 50 and the second connector 10. FIG. 8 is a cross-sectional view taken along line VIII-VIII in FIG. 1. FIG. 9 is an enlarged cross-sectional view illustrating the region IX surrounded by the dash-dot line in FIG. 8. FIG. 10 is a perspective view illustrating the exterior of the first contact 70 and the second contact 30 that are connected to each other.

For example, as illustrated in FIG. 8, the orientation of the first connector 50 is first reversed upside down. In this state, the first connector 50 is positioned so as to oppose the second connector 10 while the first connector 50 and the second connector 10 are substantially aligned with each other in the front-rear and right-left directions. Subsequently, the first connector 50 is lowered. The first connector 50 is thereby connected to the second connector 10, in other words, the connector module 1 is in the connection state. Here, the first insulator 60 engages the second connector 10. The second insulator 20 engages the first connector 50. The engagement projection 22 of the second insulator 20 engages the engagement recess 63 of the first insulator 60.

In the state of engagement as illustrated in FIG. 9, the elastic contact point 35 of each second contact 30 comes into contact with the contact point 74 of the corresponding first contact 70, and the elastic contact arm 34 having spring-like elasticity is elastically deformed inward in the front-rear direction. The first contact 70 is in contact with the second contact 30 on one side, which is the side closer to the center of the first connector 50 with respect to the center line of the corresponding longitudinal wall 62b, the center line being positioned at the center in the front-rear direction, and the first contact 70 is spaced from the second contact 30 on the other side. The first contact 70 comes into contact with the second contact 30 at one point, in other words, at the point between the elastic contact point 35 and the contact point 74, both of which are positioned on the one side. In this state, the free end 75 of the first contact 70 and the free end 36 of the second contact 30 are both positioned on the one side.

In the engaging direction of the first connector 50 with respect to the second connector 10, the free end 75 of the first contact 70 and the free end 36 of the second contact 30 are both positioned closer to the pull-out side, in other words, the upper side, than the point of contact between the elastic contact point 35 and the contact point 74. The free end 75 is closer to the pull-out side than the free end 36, and the free end 75 is disposed integrally in the bottom plate 61 and the longitudinal wall 62b. In other words, the free end 75 is embedded in the bottom plate 61. The free end 36 is disposed in the second-contact mounting groove 24 at the inner surface of the engagement projection 22 in the front-rear direction. The free end 36 is disposed inside the second-contact mounting groove 24 so as to be displaceable in the front-rear direction due to elastic deformation of the elastic contact arm 34.

The second contact 30 is bent like the letter L at the mount portion 31 and extends straight upward at the locking portion 32. The second contact 30 is bent like the letter U at the curved portion 33 and bent like the letter S at the elastic contact arm 34. The first contact 70 is bent like the letter L at the mount portion 71 and extends straight downward at the extension portion 72. The first contact 70 is bent like the letter U at the fold-back portion 73 and then extends straight upward. In the case of the first contact 70 being embedded integrally in the first insulator 60 using insert molding, the fold-back portion 73 that is shaped like the letter U increases the holding strength of the first insulator 60 that holds the first contact 70.

As can be seen from FIGS. 7 and 8, each outer wall 66 of the first insulator 60 is formed so as to extend parallel to the longitudinal wall 62b in the arrangement direction of the first contacts 70 over the entire length of the region in which the first contacts 70 are disposed, and the outer wall 66 is formed at position closer to the other side than the extension portion 72 of each first contact 70 to the other side. The extension portion 72 of the first contact 70 is interposed between the longitudinal wall 62b and the outer wall 66 and, in this state, is embedded integrally in the longitudinal wall 62b and the outer wall 66. The outer wall 66 is positioned in the front-rear direction between the extension portion 72 of the first contact 70 and the curved portion 33 of the second contact 30.

As illustrated in FIG. 9, a region R is a region in which the first contact 70 and the second contact 30 oppose each other on the other side in the state of engagement. The region R has an end that faces the pull-out side in the engaging direction of the first connector 50 with respect to the second connector 10, and the outer wall 66 of the first insulator 60 is disposed at the end of the region R or disposed at a position closer to the pull-out side than the end of the region R. In other words, the outer wall 66 is positioned at or above the upper end of the region R. The end of the outer wall 66 facing the engagement side is spaced from the projected portion 27 in the engaging direction. The end of the outer wall 66 facing the engagement side is disposed at a level similar to that of the curved portion 33 in the up-down direction or is disposed at a level closer to the pull-out side than the curved portion 33 in the up-down direction. The outer wall 66 extend from a position immediately below the mount portion 71 of the first contact 70 to the region in which the extension portion 72 extends in the up-down direction. The most part of the region R located between the fold-back portion 73 and the curved portion 33 is not the insulator, such as the first insulator 60, but is filled with air.

In the state of engagement, the extension portion 34a of the second contact 30 opposes, and is spaced from, the fold-back portion 73 of the first contact 70 that is positioned closer to the pull-out side than the extension portion 34a in the engaging direction of the first connector 50 with respect to the second connector 10. In the engaging direction of the first connector 50 with respect to the second connector 10, each projected portion 27 of the second insulator 20 is positioned closer to the pull-out side than the extension portion 34a of the corresponding second contact 30.

The projected portion 27 is disposed at a position different from that of the second contact 30 in the right-left direction. The projected portion 27 is disposed so as to adjoin the extension portion 34a of the second contact 30 in the right-left direction. The extension portions 34a and the projected portions 27 are disposed alternately in the right-left direction at the bottom plate 21.

Each projected portion 27 abuts a portion of the longitudinal wall 62b of the first insulator 60 from below, the portion being positioned between adjacent first contacts 70. Here, the second insulator 20 is not present in the space between the fold-back portion 73 and the extension portion 34a. In other words, the second insulator 20 is not present above the extension portion 34a. Moreover, the second insulator 20 is not present under the extension portion 34a, either.

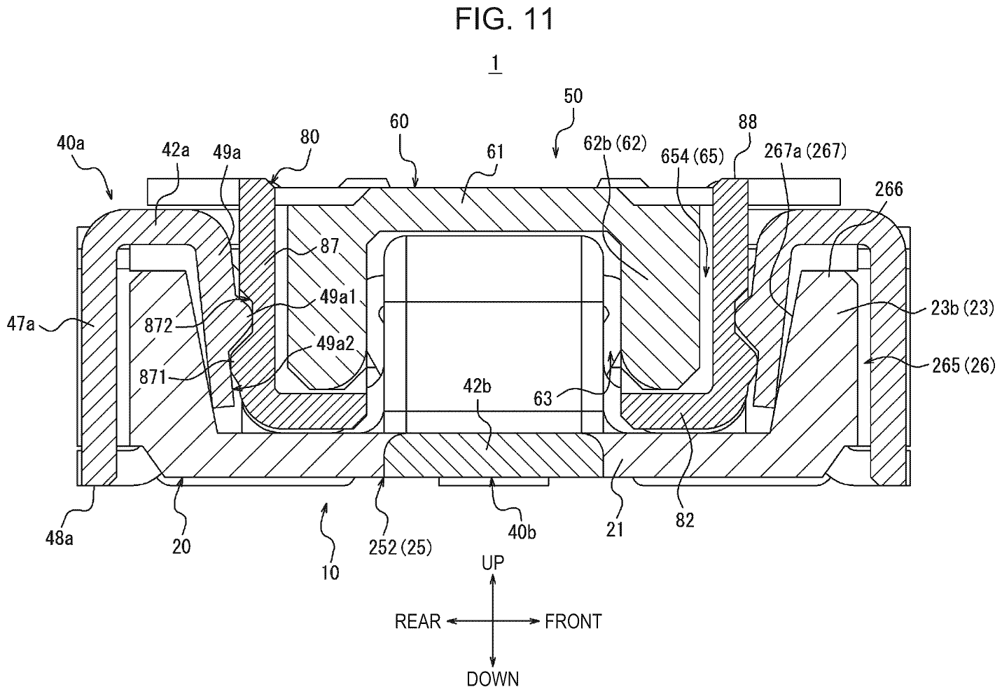

FIG. 11 is a cross-sectional view taken along line XI-XI in FIG. 1.

In the state of engagement, each first metal fitting 80 is in contact with the corresponding second metal fitting 40a. For example, the extended portions 49a of the second metal fitting 40a are in contact with the corresponding second protruding portions 87 of the first metal fitting 80. More specifically, the first fitting portion 49a1 of each extended portion 49a engages the second fitting portion 872 of the corresponding second protruding portion 87 because of the projection-recess structure. The second fitting portion 49a2 of the extended portion 49a engages the first fitting portion 871 of the corresponding second protruding portion 87 because of the projection-recess structure.

Here, the extended portion 49a having spring-like elasticity deforms elastically outward in the front-rear direction. In the state of engagement, the extended portion 49a touches the first metal fitting 80 and thereby deforms elastically toward the corresponding peripheral wall 23 of the second insulator 20. The second metal fitting 40a comes into contact with the first metal fitting 80 at two points on opposite sides in the front-rear direction using the extended portions 49a and the second protruding portions 87.

In the state of engagement, each extended portion 49a deforms toward the corresponding peripheral wall 23, and the surface of the extended portion 49a facing the peripheral wall 23 comes into contact with the abutting portion 267 of the second insulator 20. More specifically, a lower edge portion of the surface of the extended portion 49a facing the peripheral wall 23 comes into contact with the slope 267a of the abutting portion 267. In other words, in the non-engagement state, the corner of the end of the extended portion 49a, the corner facing the peripheral wall 23, is spaced from the slope 267a of the abutting portion 267, whereas in the state of engagement, the corner of the end of the extended portion 49a comes into contact with the slope 267a of the abutting portion 267.

The first metal fitting 80 receives an urging force in the direction opposite to the peripheral wall 23 from the extended portion 49a that has elastically deformed toward the peripheral wall 23. On the other hand, the extended portion 49a, which has elastically deformed toward the peripheral wall 23 and come into contact with the abutting portion 267, receives a reaction force from the slope 267a of the abutting portion 267. The urging force and the reaction force provide the second metal fitting 40a with a contact force against the first metal fitting 80.

The top surface of the second base portion 42b of the third metal fitting 40b is flush with the top surface of the bottom plate 21. The top surface of the second base portion 42b is exposed from the second portion 252 of the bottom plate 21.

In FIG. 11, the thickness of each third metal fitting 40b is substantially equal to the thickness of the second metal fitting 40a. The thickness of the third metal fitting 40b, however, may be greater than the thickness of the second metal fitting 40a in order to increase the strength of the third metal fitting 40b relative to the second metal fitting 40a, for example, in a case where the third metal fitting 40b and the second metal fitting 40a are made of the same material.

In the state of engagement, each first metal fitting 80 is in contact with the corresponding second metal fitting 40a. For example, the first protruding portion 83 of the first metal fitting 80 is in contact with the bent portion 46a of the second metal fitting 40a. More specifically, the second fitting portion 832 of the first protruding portion 83 engages the first fitting portion 46a1 of the bent portion 46a because of the projection-recess structure. The first fitting portion 831 of the first protruding portion 83 engages the second fitting portion 46a2 of the bent portion 46a because of the projection-recess structure.

Here, the bent portion 46a having spring-like elasticity deform elastically outward in the right-left direction. The bent portion 46a comes into contact with the first metal fitting 80 in the state of engagement and elastically deforms toward the corresponding peripheral wall 23 of the second insulator 20. Each first metal fitting 80 and the corresponding second metal fitting 40a come into contact with each other at one point in the right-left direction using the first protruding portion 83 and the bent portion 46a.

According to the connector module 1 of an embodiment, the first connector 50 and the second connector 10, which are sized small, can increase the impedance. In the connector module 1, each first contact 70 is in contact with the corresponding second contact 30 on the one side with respect to the longitudinal wall 62b, and the first contact 70 is spaced from the second contact 30 on the other side. In this state, both of the free end 75 and the free end 36 are positioned on the one side as is the point of contact between the first contact 70 and the second contact 30. This structure of the connector module 1 enables the free end 75 of the first contact 70 to be positioned closer to the free end 36 of the second contact 30, which can reduce the size of the stub. More specifically, the connector module 1 can reduce the distance from the point of contact to the free end 75 of the first contact 70. The connector module 1 can also reduce the distance from the point of contact to the free end 36 of the second contact 30. Accordingly, the connector module 1 can increase the impedance at the first contact 70 and the second contact 30.

In the connector module 1, the width of the extension portion 72 is smaller than the width of the fold-back portion 73 in the arrangement direction of the first contacts 70, which can increase the inductance L of each first contact 70. Accordingly, the connector module 1 can increase the impedance of the first contact 70. In the case of the first contact 70 being press-fitted in the first insulator 60, the first contact 70 may have a wide locking portion to be locked in the first insulator 60. In this case, the wide locking portion may decrease the impedance. In the first connector 50, however, the first contact 70 is embedded integrally in the first insulator 60 using insert molding, which can eliminate the necessity of the wide locking portion and reduce the width of the extension portion 72.

In the connector module 1, the first contact 70 has the fold-back portion 73 that is formed wider than the extension portion 72 in the right-left direction, which can increase the area of the metal portion at the end surface of each longitudinal wall 62b of the first insulator 60, the end surface facing the engagement side. Accordingly, the connector module 1 can increase the strength of the first connector 50.

The first connector 50 includes the outer walls 66 that extend parallel to respective longitudinal walls 62b. Each outer wall 66 is positioned closer to the other side than the extension portion 72 to the other side. Accordingly, when the first connector 50 engages the second connector 10, the connector module 1 can hold the first contact 70 and the second contact 30 such that the first contact 70 is spaced from the second contact 30 in the front-rear direction on the other side. Accordingly, the first contact 70 and the second contact 30 can come into contact with each other only on the one side of the longitudinal wall 62b. As a result, the first contact 70 and the second contact 30 can substantially increase the length of the path through which signals are transmitted, compared with the case in which the first contact 70 and the second contact 30 come into contact with each other both on the one side and on the other side in the front-rear direction. This leads to an increase in the inductance L. In addition, this reduces the stub in the state of engagement. As a result, the impedance of the first contact 70 and the second contact 30 can be increased.

In the connector module 1, the first contact 70 and the second contact 30 are spaced from each other in the front-rear direction, which provides the same effect as a capacitor between the curved portion 33 of the second contact 30 and the extension portion 72 and the fold-back portion 73 of the first contact 70. Let the capacitance be denoted by C. Due to most of the region R being filled with air, the dielectric constant of the region R decreases, which decreases the capacitance C. As a result, the impedance of the first contact 70 and the second contact 30 can be increased.

In the connector module 1, the first connector 50 includes the outer walls 66, and the first contacts 70 are embedded in the first insulator 60 using insert molding, which increases the holding strength of the first insulator 60 that holds the first contacts 70. Accordingly, the first insulator 60 of the first connector 50 holds the first contacts 70 stably. Moreover, although the connector module 1 is sized small, the connector module 1 can reduce the likelihood of solder climbing up from the mount portions 71 of the first contacts 70. Accordingly, the connector module 1 can improve the product reliability.

The first connector 50 includes the outer walls 66. Accordingly, for example, even if the first connector 50 is inclined relative to the second connector 10 in a plane extending in the front-rear and right-left directions when the first connector 50 engages the second connector 10, the connector module 1 enables the first insulator 60 to touch the second insulator 20 first. Even in the event of inclined engagement, the connector module 1 can alleviate the direct contact between the first contacts 70 and the second insulator 20 or the second contacts 30, which can reduce the likelihood of the second connector 10 breaking. This improves the product reliability of the connector module 1.

The first insulator 60 includes the outer walls 66, and the outer walls 66 and the longitudinal walls 62b can be formed integrally. Accordingly, the connector module 1 enables the outer walls 66 to be formed easily in the first connector 50, which leads to easy manufacturing of the first connector 50.

In the state of engagement, each outer wall 66 is disposed at the end of the region R facing the pull-out side or disposed closer to the pull-out side than the end of the region R. Accordingly, the most part of the region R is filled with air. This decreases the dielectric constant of the region R, leading to a decrease in the capacitance C. As a result, the impedance of the first contact 70 and the second contact 30 can be increased.

In the connector module 1, the second connector 10 includes the projected portions 27 that project so as to be positioned closer to the pull-out side than the extension portions 34a, which enables the first contacts 70 to be easily spaced from the second contacts 30 in the up-down direction. In the connector module 1, each first contact 70 is spaced from the corresponding second contact 30 in the up-down direction, which can provide the same effect as a capacitor between the fold-back portion 73 and the extension portion 34a. When the capacitance is denoted by C and the space between the fold-back portion 73 and the extension portion 34a is filled with air, the dielectric constant decreases, thereby decreasing the capacitance C. This can increase the impedance of the first contact 70 and the second contact 30.

In the connector module 1, the second insulator 20 is not present above and below the extension portion 34a, which can increase the distance between the top surface of each extension portion 34a and the top surface of adjacent projected portions 27 without increasing the height of the second connector 10. This increases the distance between each fold-back portion 73 and the corresponding extension portion 34a in the engaging direction. As a result, the gap of the capacitor increases, and the capacitance C decreases, which leads to an increase in the impedance of the first contact 70 and the second contacts 30.

In the connector module 1, the second connector 10 includes projected portions 27, which reduces the likelihood of the first connector 50 bending at the center thereof in the right-left direction when the first connector 50 engages the second connector 10 and thereby reduces the likelihood of the breakage of the first insulator 60. In the connector module 1, the first insulator 60 of the first connector 50 can be brought into contact with the projected portions 27 of the second connector 10 as well as with the second metal fittings 40a during the engagement. This can alleviate the load applied to the first insulator 60 during the engagement.

The second insulator 20 includes the projected portions 27, and the projected portions 27 can be formed integrally with the bottom plate 21. Accordingly, the connector module 1 enables the projected portions 27 to be formed easily in the second connector 10, which leads to easy manufacturing of the second connector 10.

In the connector module 1, the end surface of each first metal fitting 80, which comes into contact with the corresponding second metal fitting 40a in the state of engagement, is positioned closer to the engagement side than the end surface of each first contact 70, the end surfaces of the first metal fitting 80 and the first contact 70 both facing the engagement side in the engaging direction. This enables the first contact 70 and the second contact 30 to be spaced from each other easily. Even if the second connector 10 does not include the projected portions 27, the connector module 1 can cause each first contact 70 to be spaced from the corresponding second contact 30.

In addition, the connector module 1 can increase the lengths of the first metal fitting 80 and the second metal fitting 40a in the engaging direction. Accordingly, the connector module 1 can increase an effective engagement length between the first metal fitting 80 and the second metal fitting 40a. For example, the effective engagement length of the first metal fitting 80 corresponds to the width, in the up-down direction, between the second fitting portion 872 and the surface of the second base portion 82 facing the engagement side. For example, the effective engagement length of the second metal fitting 40a corresponds to the width, along the extended portion 49a, between the first fitting portion 49a1 and the surface of the second base portion 42a facing the pull-out side.

This can increase the length of the extended portion 49a having spring-like elasticity, in other words, increase the spring length, which improves the reliability of contact between the first metal fitting 80 and the second metal fitting 40a in the state of engagement. The connector module 1 can provide the reliability of contact for the entire module even if each first contact 70 comes into contact with the corresponding second contact 30 at one point.

The first contacts 70 are embedded integrally in the first insulator 60 using insert molding, which improves the holding strength of the first insulator 60 holding the first contacts 70.

The second insulator 20 includes the abutting portions 267. When each extended portion 49a deforms elastically toward the corresponding peripheral wall 23 in the state of engagement, the extended portion 49a touches the abutting portion 267. The extended portion 49a elastically deforms toward the peripheral wall 23 and thereby provides an urging force in the direction opposite to the peripheral wall 23. The extended portion 49a elastically deforms toward the peripheral wall 23 and comes into contact with the abutting portion 267 and thereby receives a reaction force. The urging force and the reaction force increase the contact pressure of the second metal fitting 40a against the first metal fitting 80. Accordingly, the second connector 10 can hold the first connector 50 securely.

Each abutting portion 267 includes the slope 267a. As a result, the extended portion 49a, which deforms elastically toward the peripheral wall 23, can come into contact with the abutting portion 267 in an earlier stage during engagement compared with a case where the abutting portion 267 is provided as a flat surface extending perpendicularly to the bottom plate 21. As a result, the above-described advantageous effect related to the second connector 10 holding the first connector 50 can be further enhanced.

The first fitting portion 49a1 of the second connector 10 includes the projection, and the first fitting portion 871 of the first metal fitting 80 of the first connector 50 also includes the projection. When the first connector 50 engages the second connector 10, the projection of the first fitting portion 871 engages the projection of the first fitting portion 49a1, which provides an improved clicking touch. Moreover, in the state of engagement, the second connector 10 can increase the pull-out force required when the first connector 50 is detached from the second connector 10.

Each second metal fitting 40a includes the elastically deformable extended portions 49a that come into contact with the corresponding first metal fitting 80 in the state of engagement. The extended portions 49a, which exert elastic forces to the first metal fitting 80, can reliably maintain the state of connection with the first metal fitting 80. Accordingly, the electrical continuity can be maintained reliably between the second metal fitting 40a and the first metal fitting 80 in the state of engagement.

In the second connector 10, each third metal fitting 40b attached to the engagement projection 22 and the corresponding second metal fitting 40a attached to a peripheral wall 23 are separate members. This reduces a negative impact caused due to the first connector 50 hitting a metal fitting during engagement compared with a known art in which these metal fittings are formed integrally as one piece. For example, when the first connector 50 hits a metal fitting at the engagement projection 22 or at the peripheral wall 23, the likelihood of the impact extending to the other metal fitting is reduced. This reduces the occurrence of breakage of the metal fittings that include the second metal fitting 40a and the third metal fittings 40b. The reduction of the occurrence of breakage of the metal fittings leads to a reduction in the occurrence of breakage of the second insulator 20 to which the metal fittings are attached. This improves the product reliability of the second connector 10.

Assume that the first connector 50 and the second connector 10 engage each other in a misaligned state and that the first connector 50 hits a second metal fitting 40a on the peripheral wall 23 during the engagement and causes the second metal fitting 40a and the peripheral wall 23 to deform and incline outward in the right-left direction. Even in this case, the likelihood of the impact extending to the engagement projection 22 is reduced. The likelihood of deformation of the third metal fitting 40b can be reduced since the second metal fitting 40a and the third metal fitting 40b are separate members. Assume that the first connector 50 hits a third metal fitting 40b at the engagement projection 22 during engagement and causes the third metal fitting 40b and the engagement projection 22 to deform inward in the right-left direction. Even in this case, the likelihood of the impact extending to the peripheral wall 23 is reduced. The deformation of the second metal fitting 40a can be reduced since the second metal fitting 40a and the third metal fitting 40b are separate members. Accordingly, the metal fittings behave differently and independently at the engagement projection 22 and at the peripheral wall 23. The behavior of the metal fitting at the engagement projection 22 does not readily propagate to the metal fitting at the peripheral wall 23, and vice versa. Accordingly, the metal fittings perform expected functions reliably, and the occurrence of the breakage is reduced.

The reduction of the occurrence of breakage of the metal fittings and the second insulator 20 reduces the likelihood of displacement of the first connector 50 and the second connector 10 relative to each other, in other words, reduces the likelihood of displacement of the first connector 50 in the longitudinal direction of the second connector 10, during and after the engagement. As a result, electrical continuity between the first contacts 70 and the corresponding second contacts 30 can be achieved exactly as specified in design. The likelihood of the connector module 1 loosening also can be reduced after the engagement. The positioning function of the first connector 50 and the second connector 10 relative to each other can be maintained. As a result, the first connector 50 and the second connector 10 do not come off easily from each other, which improves the product reliability of the connector module 1.

In the second connector 10, the second metal fitting 40a and the third metal fitting 40b are different members, which enables the strength of one of the second metal fitting 40a and the third metal fitting 40b to increase relative to the other. In the second connector 10, the second metal fitting 40a and the third metal fitting 40b are attached to different members, such as the engagement projection 22 and the peripheral wall 23, for the different purposes. The second metal fitting 40a and the third metal fitting 40b can be formed so as to have appropriate strengths suitable for the different positions and purposes. Assume that these metal fittings are formed integrally into one piece as is the case for the known art. When it is necessary to reduce the strength of a portion of the metal fitting at the engagement projection 22 or at the peripheral wall 23, the strength of the other portion of the metal fitting decreases.

For example, the third metal fitting 40b attached to the engagement projection 22 is provided mainly for the purpose of improving the sturdiness of the engagement projection 22. On the other hand, one of the purposes of the second metal fitting 40a attached to the peripheral wall 23 is to provide electrical connection with the first metal fitting 80 in the state of engagement. For this purpose, the second metal fitting 40a includes the elastically deformable extended portions 49a.

Accordingly, the second metal fitting 40a may be preferably made of a material having a suitable strength to serve as a spring, while the third metal fitting 40b may be made of a material that is greater in strength. In the second connector 10, the second metal fitting 40a and the third metal fitting 40b can be formed so as to have appropriate strengths suitable for respective purposes. If, for example, the metal fittings are formed integrally into one piece as is the case for the known art, the necessity to form elastically deformable contact arms at the peripheral walls leads to a decrease in the overall strength of the metal fitting, which results in a decrease in the sturdiness of the engagement projection.

The material of the second metal fitting 40a, however, is different from that of the third metal fitting 40b. Accordingly, these metal fittings can be produced easily so as to increase the strength of one of the second metal fitting 40a and the third metal fitting 40b relative to the strength of the other. For example, the materials of the second metal fitting 40a and the third metal fitting 40b can be selected appropriately to meet the objectives of these metal fittings.

The third metal fitting 40b, which is made of a material stronger than that of the second metal fitting 40a, improves the sturdiness of the engagement projection 22 to which the third metal fitting 40b is attached. This reduces the occurrence of breakage of the engagement projection 22 of the second insulator 20 to which the third metal fitting 40b is attached. Accordingly, this improves the product reliability of the second connector 10.

In the case of the third metal fitting 40b having a thickness greater than that of the second metal fitting 40a, the strength of the third metal fitting 40b becomes greater than that of the second metal fitting 40a even if, for example, the third metal fitting 40b and the second metal fitting 40a are made of the same material. With this configuration, the sturdiness of the engagement projection 22 to which the third metal fitting 40b is attached can be also increased as is the above case.

In the second connector 10, each third metal fitting 40b includes the mount portion 44b to be mounted on the circuit board CB2, which improves the sturdiness of the third metal fitting 40b. This reduces the deformation of the third metal fitting 40b even when a load is applied thereto. As a result, dimensional accuracy and shape integrity of the second connector 10 can be maintained during the engagement. This improves, for example, the sturdiness of the engagement projection 22 to which the third metal fitting 40b is attached. This can reduce the occurrence of breakage or deformation of the engagement projection 22 and can reduce the likelihood of the second connector 10 loosening or being displaced in the longitudinal direction.

The mount portion 44b includes the bottom surface facing the circuit board CB2, and the mount portion 44b can receive the external force acting on the third metal fitting 40b. The mount portion 44b is fixed to the circuit board CB2, and the third metal fitting 40b is thereby fixed to the circuit board CB2. As a result, even if an external force acts on the third metal fitting 40b, the mount portion 44b can absorb the resulted impact. This improves the sturdiness of the third metal fitting 40b extending in the longitudinal direction of the second connector 10. Consequently, this improves the sturdiness of the engagement projection 22 extending in the longitudinal direction of the second connector 10.

The first base portion 41b and the second base portion 42b of the third metal fitting 40b are formed integrally so as to have the crank-like shape as a whole. Accordingly, the entire third metal fitting 40b is integrally fitted in the second insulator 20 so as to follow the shape of the end portion of the engagement projection 22 and the shape of the bottom plate 21. This increases the holding strength of the second insulator 20 holding the third metal fitting 40b.

The first mount portions 44a of the second metal fitting 40a are positioned respectively at both sides of the third metal fitting 40b in the transverse direction of the second connector 10. The second mount portions 48a of the second metal fitting 40a are positioned respectively at both sides of the third metal fitting 40b in the transverse direction of the second connector 10. This structure increases the mounting strength of the second metal fitting 40a mounted on the circuit board CB2. Accordingly, this improves the sturdiness of the second metal fitting 40a and the transverse wall 23a in the right-left direction.

A pair of the first mount portions 44a are disposed substantially at the same position of the mount portion 44b in the right-left direction. Accordingly, three mount portions are aligned along an imaginary line extending in the front-rear direction. This increases the mounting strength of the second connector 10 mounted on the circuit board CB2. Even if the first connector 50 engages the second connector 10 in a misaligned state in which the first connector 50 is, for example, rotated relative to the second connector 10 by a certain degree about an axis extending in the up-down direction, the second connector 10 remains to be mounted on the circuit board CB2. Similarly, even if the circuit board CB2 having the second connector 10 mounted thereon is rotated after the engagement, the second connector 10 remains to be mounted on the circuit board CB2. Accordingly, this improves the sturdiness of the second connector 10 mounted on the circuit board CB2.

The second metal fittings 40a are attached to respective transverse walls 23a, which improves the sturdiness of the transverse walls 23a at both ends of the peripheral walls 23 in the right-left direction. This further reduces the occurrence of breakage of the transverse walls 23a of the second insulator 20 to which respective second metal fittings 40a are attached. As a result, the product reliability of the second connector 10 is further improved.

Those skilled in the art can obviously implement the present disclosure in a form other than the above-described embodiment without departing from the spirit or the essential features of the present disclosure. As such, the above description is only illustrative and should not be construed as limiting. The scope of the disclosure is not limited by the above description but by the appended claims. Variations that fall within the scope of the claim or the equivalents thereof are to be included in the present disclosure.

For example, the shapes, sizes, arrangements, and orientations of elements as well as the number of elements are not limited to what is disclosed in the above description and in the drawings. The shapes, sizes, arrangements, and orientations of elements as well as the number of elements may be changed arbitrarily insofar as the specified functions can be implemented.

The methods of assembling the second connector 10 and the first connector 50 are not limited to those described above. The method of assembling the second connector 10 and the first connector 50 may be any arbitrary methods insofar as the assembled second connector 10 and the assembled first connector 50 function appropriately. For example, in the second connector 10, at least either of the second contacts 30 or the second metal fittings 40a may be embedded in the second insulator 20 by insert molding rather than by press-fitting. The third metal fittings 40b may be attached to the second insulator 20 by press-fitting rather than by insert molding. For example, in the first connector 50, the first contacts 70 may be attached to the first insulator 60 by press-fitting rather than by insert molding. The first metal fittings 80 may be embedded in the first insulator 60 by insert molding rather than by press-fitting.

In the above description of the embodiment, each first contact 70 includes the fold-back portion 73 that connects the free end 75 to the extension portion 72. The first contact 70, however, does not need to include the fold-back portion 73. In this case, the first contact 70 may be shaped like the letter L as a whole. The entire shape of the first contact 70 is substantially formed with the mount portion 71 that is the L-shaped extension extending outward in the front-rear direction and also with the extension portion 72 that extends upward from the upper end of the mount portion 71.

In the above description of the embodiment, the free end 36 of the second contact 30 is positioned closer to the one side than the elastic contact point 35, but the position of the free end 36 is not limited to this. For example, the elastic contact arm 34 of the second contact 30 does not need to be shaped like the letter S. The elastic contact arm 34 may be extended considerably toward the one side, bent upward, and then bent toward the other side so that the elastic contact point 35 and the free end 36 may be disposed at the substantially same position in the front-rear direction.

In the above description of the embodiment, the width of the extension portion 72 is smaller than the width of the fold-back portion 73. However, the width of the extension portion 72 may be, for example, substantially equal to the width of the fold-back portion 73.

In the above description of the embodiment, the first connector 50 includes the outer walls 66 that extend over the entire length of the region in which the first contacts 70 are arranged. The outer walls 66 of the first connector 50, however, may extend only partially over the length of the region in which the first contacts 70 are arranged. Moreover, the first connector 50 does not need to have the outer walls 66.

In the above description of the embodiment, the first insulator 60 includes the outer walls 66. The outer walls 66, however, may be formed as part of the first insulator 60. In place of this or in addition to this, the outer walls 66 may be made, for example, of a resin or a metal as members different from the first insulator 60.

In the above description of the embodiment, each outer wall 66 is disposed at the end of the region R facing the pull-out side or disposed at a position closer to the pull-out side than the end of the region R. The outer wall 66, however, may be positioned inside the region R.

In the above description of the embodiment, the second connector 10 includes the projected portions 27 in the entire region in which the second contacts 30 are arranged. The second connector 10, however, includes the projected portions 27 in part of the region in which the second contacts 30 are arranged. Moreover, the second connector 10 does not need to include the projected portions 27.

In the above description of the embodiment, the second insulator 20 includes the projected portions 27. The projected portions 27, however, may be formed as the part of the second insulator 20. In place of this or in addition to this, the projected portions 27 may be made, for example, of a resin or a metal as members different from the second insulator 20.

In the above description of the embodiment, the outer walls 66 that project outward in the front-rear direction are disposed in the first insulator 60, and the projected portions 27 that project in the up-down direction are disposed in the second insulator 20. However, the elements that correspond to the outer walls 66 projecting outward in the front-rear direction may be disposed in the second insulator 20. For example, these elements may be disposed so as to extend in the right-left direction along respective inner surfaces of the longitudinal walls 23b of the second insulator 20. Different elements that correspond to the projected portions 27 projecting in the up-down direction may be disposed in the first insulator 60. Such different elements may be implemented as projected portions of the longitudinal walls 62b. In the above embodiment, the top surfaces of the longitudinal walls 62b are disposed so as to be flush with the top surfaces of the fold-back portions 73 of the first contacts 70. However, the longitudinal walls 62b may have, for example, projected portions that project upward from respective top surfaces of the fold-back portions 73 of the first contacts 70.

In the above description of the embodiment, the first contacts 70 are disposed such that the cut surfaces of all of the first contacts 70 face in the right-left direction. The first contacts 70, however, may be disposed such that the rolled surfaces of all of the first contacts 70 face in the right-left direction or that the cut surfaces of some of the first contacts 70 may face in the right-left direction and the rolled surfaces of some of the first contacts 70 may face in the right-left direction.

In the above description of the embodiment, the second contacts 30 are disposed such that the cut surfaces of all of the second contacts 30 face in the right-left direction. The second contacts 30, however, may be disposed such that the rolled surfaces of all of the second contacts 30 face in the right-left direction or that the cut surfaces of some of the second contacts 30 may face in the right-left direction and the rolled surfaces of some of the second contacts 30 may face in the right-left direction.

In the above description, the end surface of each first metal fitting 80 is positioned closer to the engagement side in the engaging direction than the end surface of each first contact 70. In the engaging direction, the end surface of the first metal fitting 80 facing the engagement side may be positioned at the same level of the end surface of each first contact 70 facing the engagement side or may be positioned closer to the pull-out side than the end surface of the first contact 70.

In the above description of the embodiment, the top surface of a portion in the first-metal-fitting mounting portion 65, the portion extending straight in the right-left direction between each first wall portion 651 and the corresponding second wall portion 652, is positioned at the same height level as that of the top surface of each first contact 70 held by the first insulator 60. The top surface of the above portion, however, may be positioned higher than the top surface of the first contact 70 held by the first insulator 60. As a result, in the engaging direction, the end surface of the first metal fitting 80 facing the engagement side comes to a position closer to the engagement side than the end surface of the first contact 70 facing the engagement side.

In the above description of the embodiment, a pair of the extended portions 49a are disposed in the second metal fitting 40a. However, multiple pairs of the extended portions 49a may be disposed at arbitrary positions in the second metal fitting 40a, or alternatively, an arbitrary number (more than one) of the extended portions 49a that are not paired may be disposed at arbitrary positions.

In the above description of the embodiment, the extended portions 49a are positioned at respective longitudinal walls 23b. The extended portions 49a, however, may be positioned at the transverse wall 23a in place of, or in addition to, the longitudinal walls 23b.

In the above description of the embodiment, the second insulator 20 includes the abutting portions 267. The second insulator 20, however, does not need to include the abutting portions 267 at all. The extended portions 49a of the second metal fitting 40a do not need to come into contact with the second insulator 20 in the state of engagement.

In the above description of the embodiment, each abutting portion 267 includes the slope 267a, and the slope 267a extends toward the engagement side in the engaging direction while inclining inward from the corresponding longitudinal wall 23b. The abutting portion 267, however, may include any arbitrary element other than the slope 267a, the element being disposed at a position inside of the peripheral wall 23 near the engagement side. For example, the abutting portion 267 may include a staircase-like element, which inclines inward while descending toward the engagement side, in place of the slope 267a that inclines steplessly inward from the peripheral wall 23.

The abutting portion 267 does not need to be formed so as to come more inward from the peripheral wall 23 as it comes closer to the engagement side. For example, the abutting portion 267 may include a flat surface in place of the slope 267a, the flat surface extending perpendicularly to the bottom plate 21. The abutting portion 267 may include a curved surface, in place of the slope 267a or the flat surface, that is curved with an arbitrary curvature so as to swell out. The abutting portion 267 may be disposed at each transverse wall 23a in place of, or in addition to, the longitudinal wall 23b.

In the above description of the embodiment, the corner of the extended portion 49a that faces the peripheral wall 23 and touches the abutting portion 267 has a right-angled shape. The corner, however, may have a round shape. Accordingly, when the second metal fitting 40a touches the second insulator 20 at the abutting portion 267, the likelihood of breakage of the second insulator 20 is reduced. As a result, the contact pressure applied to the first connector 50 via the extended portion 49a is maintained for a longer period of time. Accordingly, this improves the sturdiness of the second connector 10 and the product reliability of the second connector 10.

In the above description of the embodiment, the second metal fitting 40a and the third metal fitting 40b are separated from each other. However, the second metal fitting 40a and the third metal fitting 40b do not need to be separated but may be connected. In this case, the second metal fitting 40a and the third metal fitting 40b may be formed integrally but may have different strengths. For example, the metal fitting in which the second metal fitting 40a and the third metal fitting 40b are integrated may be made of a functionally graded material. More specifically, in the metal fitting, the material of a portion for the third metal fitting 40b may be different from the material of a portion for the second metal fitting 40a so that the portion for the third metal fitting 40b may have a greater strength. For example, the metal fitting in which the second metal fitting 40a and the third metal fitting 40b are integrated may be formed so as to have different thicknesses. More specifically, the thickness of the portion for the third metal fitting 40b may be greater than that of the portion for the second metal fitting 40a.

In the above description of the embodiment, the strength of the third metal fitting 40b is greater than the strength of the second metal fitting 40a. However, the strength of the second metal fitting 40a may be greater than that of the third metal fitting 40b.

In the above description of the embodiment, the thickness of the third metal fitting 40b may be greater than the thickness of the second metal fitting 40a in order to increase the strength of the third metal fitting 40b relative to that of the second metal fitting 40a. However, the thickness of the third metal fitting 40b may be, for example, smaller than that of the second metal fitting 40a, but the strength of the third metal fitting 40b may be greater than that of the second metal fitting 40a. On the contrary, the strength of the third metal fitting 40b may be smaller than that of the second metal fitting 40a, but the thickness of the third metal fitting 40b may be greater than that of the second metal fitting 40a.

In the above description of the embodiment, the mount portion 44b of the third metal fitting 40b is positioned directly below the transverse wall 23a. The mount portion 44b, however, may be disposed at a position near the engagement projection 22 so that the mount portion 44b may come to a position at which an external force is likely to act in the third metal fitting 40b.

In the above description of the embodiment, each second metal fitting 40a is attached to the corresponding transverse wall 23a. The second metal fitting 40a, however, does not need to be attached to the transverse wall 23a and may be attached, for example, only to the longitudinal walls 23b.

In the above description of the embodiment, the first mount portions 44a of the second metal fitting 40a are disposed respectively at both sides of the third metal fitting 40b in the transverse direction of the second connector 10, and the second mount portions 48a of the second metal fitting 40b are also disposed respectively at both sides of the third metal fitting 40b in the transverse direction of the second connector 10. However, either the first mount portions 44a or the second mount portions 48a may be disposed respectively at both sides of the third metal fitting 40b in the transverse direction of the second connector 10. Only one first mount portion 44a or three or more first mount portions 44a may be provided rather than the two first mount portions 44a. Similarly, only one second mount portion 48a or three or more second mount portions 48a may be provided rather than the two second mount portions 48a.

The connector module 1 described above is mounted in an electronic device that includes the circuit board CB1 and the circuit board CB2. For example, the type of the electronic device includes any communication terminal equipment such as a smartphone, any wearable device such as a smart watch, a wireless earphone, or a smart glasses, and any information processing equipment such as a personal computer, a copier, a printer, a facsimile, or a multifunction printer. Moreover, the type of the electronic device includes any arbitrary industrial equipment.

In the above electronic devices, the connector module 1 can increase the impedance even if the connector module 1 is sized small.

The following concepts can be extracted from the present disclosure.

(1) A connector module includes a first connector and a second connector, and the first connector and the second connector are configured to engage each other. The first connector includes a first insulator that includes a first sidewall of a first peripheral wall and is configured to engage the second connector. The first connector also includes a plurality of first contacts, each first contact being attached to the first sidewall and including a first mount portion and a first free end positioned opposite to the first mount portion. The second connector includes a second insulator that includes a second sidewall of a second peripheral wall and is configured to engage the first connector. The first connector also includes a plurality of second contacts, each second contact being attached to the second sidewall and including a second mount portion and a second free end positioned opposite to the second mount portion. In a state of engagement state between the first connector and the second connector, the first contact and the second contact are in contact with each other on one side of the first sidewall, the one side being closer to a center of the first connector, and are separated from each other on an other side of the first sidewall. In the state of engagement, the first free end and the second free end are positioned on the one side.

(2) In the connector module described in (1) above, the first contact includes a first extension portion being continuous to the first mount portion, and a fold-back portion connecting the first extension portion and the first free end to each other. In addition, in an arrangement direction of the plurality of first contacts, a width of the first extension portion is smaller than a width of the fold-back portion.

(3) In the connector module described in (2) above, the first connector includes an outer wall extending in the arrangement direction of the plurality of first contacts in at least part of a region in which the plurality of first contacts is arranged, the outer wall being positioned closer to the other side than the first extension portion.

(4) In the connector module described in (3) above, the first insulator includes the outer wall.

(5) In the connector module described in (3) or (4) above, in an engaging direction, the outer wall is disposed from the first mount portion of the first contact into a region in which the first extension portion is present.

(6) In the connector module described in any one of (2) to (5) above, the second contact includes a second extension portion. In a state of engagement, the fold-back portion of the first contact opposes the second extension portion with a space interposed therebetween, the fold-back portion being positioned closer to a pull-out side of the first connector in an engaging direction of the first connector with respect to the second connector. The second connector includes a projected portion projecting further toward the pull-out side than the second extension portion.

(7) In the connector module described in (6) above, the second insulator includes the projected portion.

(8) In the connector module described in any one of (1) to (7) above, the first connector includes a first metal fitting attached to the first peripheral wall, and the second connector includes a second metal fitting attached to the second peripheral wall and configured to be in contact with the first metal fitting in the state of engagement. In an engaging direction of the first connector with respect to the second connector, an end surface of the first metal fitting is positioned closer to an engagement side of the first connector than an end surface of the first contact, the end surfaces of the first metal fitting and the first contact facing the engagement side.

(9) In the connector module described in any one of (1) to (8) above, the first contact and the first insulator are formed integrally using insert molding.

(10) An electronic device includes the connector module described in any one of (1) to (9) above.

### REFERENCE SIGNS

1 connector module
10 second connector
20 second insulator
21 bottom plate
22 engagement projection
23 peripheral wall (second peripheral wall)
23a transverse wall
23b longitudinal wall (second sidewall)
24 second-contact mounting groove
25 third-metal-fitting holding portion
251 first portion
252 second portion
253 third portion
26 second-metal-fitting mounting portion
261 first wall portion
262 second wall portion
263 third wall portion
264 first mounting groove
265 second mounting groove
266 fourth wall portion
267 abutting portion
267a slope
27 projected portion
30 second contact
31 mount portion (second mount portion)
32 locking portion
33 curved portion
34 elastic contact arm
34a extension portion (second extension portion)
35 elastic contact point
36 free end (second free end)
40a second metal fitting
41a first base portion
42a second base portion
43a protruding portion
44a first mount portion
45a first locking portion
46a bent portion
46a1 first fitting portion
46a2 second fitting portion
47a second locking portion
48a second mount portion
49a extended portion
49a1 first fitting portion
49a2 second fitting portion
40b third metal fitting
41b first base portion
42b second base portion
43b wide portion
44b mount portion
50 first connector
60 first insulator
61 bottom plate
62 peripheral wall (first peripheral wall)
62a transverse wall
62b longitudinal wall (first sidewall)
63 engagement recess
64 first-contact holding portion
65 first-metal-fitting mounting portion
651 first wall portion
652 second wall portion
653 first mounting groove
654 second mounting groove
66 outer wall
70 first contact
71 mount portion (first mount portion)
72 extension portion (first extension portion)
73 fold-back portion
74 contact point
75 free end (first free end)
80 first metal fitting
81 first base portion
82 second base portion
83 first protruding portion
831 first fitting portion
832 second fitting portion
84 first mount portion
85 first locking portion
86 bent portion
87 second protruding portion
871 first fitting portion
872 second fitting portion
88 second mount portion
89 second locking portion
CB1 circuit board
CB2 circuit board
R region

1. A connector module comprising:
a first connector; and
a second connector,
wherein the first connector and the second connector are configured to engage each other,
wherein the first connector comprises
an outer wall,
a first insulator comprising a first sidewall of a first peripheral wall and being configured to engage the second connector, and
a plurality of first contacts, each first contact being attached to the first sidewall and comprising a first mount portion and a first free end positioned opposite to the first mount portion,
wherein the second connector comprises
a second insulator comprising a second sidewall of a second peripheral wall and being configured to engage the first connector, and
a plurality of second contacts, each second contact being attached to the second sidewall and comprising a second mount portion and a second free end positioned opposite to the second mount portion,
wherein in a state of engagement state between the first connector and the second connector, the first contact and the second contact are in contact with each other on one side of the first sidewall, the one side being closer to a center of the first connector, and are separated from each other on an other side of the first sidewall, and
wherein in the state of engagement, the first free end and the second free end are positioned on the one side, and
wherein the outer wall is disposed at an end, of a region in which the first contact and the second contact oppose each other on the other side, that faces a pull-out side of the first connector with respect to the second connector and disposed at a position closer to the pull-out side than the end of the region.

2. The connector module according to claim 1,
wherein the first contact comprises
a first extension portion being continuous to the first mount portion, and
a fold-back portion connecting the first extension portion and the first free end to each other, and
wherein in an arrangement direction of the plurality of first contacts, a width of the first extension portion is smaller than a width of the fold-back portion.

3. The connector module according to claim 2,
wherein the first connector comprises an outer wall extending in the arrangement direction of the plurality of first contacts in at least part of a region in which the plurality of first contacts is arranged, the outer wall being positioned closer to the other side than the first extension portion.

4. The connector module according to claim 3,
wherein the first insulator comprises the outer wall.

5. The connector module according to claim 3,
wherein in an engaging direction, the outer wall is disposed from the first mount portion of the first contact into a region in which the first extension portion is present.

6. The connector module according to claim 2,
wherein the second contact comprises a second extension portion,
wherein in a state of engagement, the fold-back portion of the first contact opposes the second extension portion with a space interposed therebetween, the fold-back portion being positioned closer to a pull-out side of the first connector in an engaging direction of the first connector with respect to the second connector, and
wherein the second connector comprises a projected portion projecting further toward the pull-out side than the second extension portion.

7. The connector module according to claim 6,
wherein the second insulator comprises the projected portion.

8. The connector module according to claim 1,
wherein the first connector comprises a first metal fitting attached to the first peripheral wall,
wherein the second connector comprises a second metal fitting attached to the second peripheral wall and configured to be in contact with the first metal fitting in the state of engagement, and
wherein in an engaging direction of the first connector with respect to the second connector, an end surface of the first metal fitting is positioned closer to an engagement side of the first connector than an end surface of the first contact, the end surfaces of the first metal fitting and the first contact facing the engagement side.

9. The connector module according to claim 1,
wherein the first contact and the first insulator are formed integrally using insert molding.

10. An electronic device comprising:
the connector module according to claim 1.

11. The connector module according to claim 1,
wherein the outer wall is formed so as to extend parallel to the first sidewall in an arrangement direction of the first contacts over the entire length of a region in which the first contacts are disposed, and the outer wall is formed at position closer to the other
